(19) United States
(12) Patent Application Publication
(10) Pub. No.: US 2021/0086877 A1
(43) Pub. Date: Mar. 25, 2021

(54) METHOD FOR ANALYZING HYDROELASTIC EFFECT OF A MARINE STRUCTURE

(71) Applicant: DALIAN UNIVERSITY OF TECHNOLOGY, Dalian (CN)

(72) Inventors: Zhe SUN, Dalian (CN); Yanzeng DENG, Dalian (CN); Guiyong ZHANG, Dalian (CN); Zhi ZONG, Dalian (CN); Hao WANG, Beijing (CN)

(21) Appl. No.: 16/950,886

(22) Filed: Nov. 17, 2020

Related U.S. Application Data
(63) Continuation-in-part of application No. PCT/CN2019/115597, filed on Nov. 5, 2019.

(30) Foreign Application Priority Data
Mar. 22, 2019 (CN) 201910223524.X
May 17, 2019 (CN) 201910413625.3

(51) Int. Cl. B63B 71/10; G06F 30/15

(52) U.S. Cl. CPC B63B 71/10; G06F 2111/10; G06F 30/15

(57) ABSTRACT

Disclosed is a method for analyzing hydroelastic effect of a marine structure based on moving particle semi-implicit method and modal superposition method. The method is based on a fluid dynamic solver of a moving particle semi-implicit method (MPS) and a structural response solver of a mode superposition method, and the fluid dynamic solver and the structural response solver achieve strong coupling in a time domain in an iterative mode. According to the present disclosure, the deficiency of the traditional potential flow-based hydroelesticity calculation (i.e. cannot directly simulate the severe deformation of the free surface and the slamming phenomenon of the ship body) is improved, and the problem of mutual influence between the rigidity of the structure and the flexible motion modal is considered.

### CROSS-REFERENCE TO RELATED APPLICATIONS

This application is a continuation-in-part of application of International Application No. PCT/CN2019/115597, filed Nov. 5, 2019, which claims the priority to Chinese application no. 201910223524.X, filed Mar. 22, 2019, and Chinese application no. 201910413625.3, filed May 17, 2019, the contents of which are incorporated herein by reference in their entirety.

### FIELD OF TECHNOLOGY

The disclosure relates to a method for analyzing hydroelastic effect of a marine structure based on moving particle semi-implicit method (MPS) and modal superposition method, belonging to the field of marine engineering.

### BACKGROUND

As ships and marine structures become increasingly larger and faster, the natural frequency of their structures and the encountered wave frequency tend to be in the same range. This means that the hydroelastic effect is becoming more and more important for the overall fatigue analysis of marine structures.

The analysis of structural integrity in this case requires time-domain simulation. Since the traditional potential-flow-based solvers cannot directly simulate the violent deformation of the free surface during slamming, it requires a CFD-based solver to perform flow calculations. Partial combination or full application of the CFD model based on viscous flow is the ultimate goal of hydroelastic calculation.

Compared with the traditional grid-based CFD methods, particle methods such as SPH and MPS do not have grid distortion problems, and the flow field is updated by the Lagrangian method, which is very suitable for simulating large free surface deformation. Moving Particle Semi-implicit (MPS), as one of the mainstream particle methods, has been improved and applied to various severe fluid and structural interaction problems. In addition, the typical motion of the ship is large rigid body motion plus relatively small elastic deformation. This means that the modal superposition theory is sufficient to accurately calculate the elastic deformation. However, in the traditional hydroelastic analysis, the interaction between the rigid body and the elastic modal is not considered, and the rigid body and the elastic part are only related to each other in the sense of the hydrodynamic coefficient of the cross term.

### SUMMARY

According to the technical problems mentioned above, a method for analyzing hydroelastic effect of a marine structure based on moving particle semi-implicit method and modal superposition method is provided. The marine structure can be a ship, a semi-submersible platform, or models thereof. The technical means adopted by the present invention are as follows:

Disclosed is a method for solving a strong nonlinear time domain hydroelasticity problem based on moving particle semi-implicit method and modal superposition method, and in the time domain, the solutions are decomposed into a number of time intervals with small intervals. Assuming that the information of the flow field and structural motion in the previous time step (or initial moment) is known, the following calculation is performed on the current time step. The specific steps are as follows:

S1. spatially discretizing a boundary of the flow field with mesh-less discrete points to avoid the difficulty of re-meshing caused by strong nonlinear free surface motion and large rigid body displacement of the structure, wherein the boundary is a surface of a marine structure, e.g., a ship, a semi-submersible platform, or models thereof, wherein if a previous time step is initial time, velocity and intensity of pressure of fluid particles need to be initialized;

S2. determining an estimated value of a structural boundary position of a current time step according to motion information of a solid boundary of the previous time step, wherein if the previous time step is the initial time, an initial value of a structural motion is adopted;

S3. updating a position and a velocity of fluid particles by Navier-Stokes equation according to the flow field information of the previous time step, excluding fluid pressure;

S4. deriving a pressure Poisson equation and solving the pressure Poisson equation;

S5. updating the position and the velocity of the fluid particles using the pressure value obtained in S4;

S6. solving the governing equation of solid response which couples the rigid body and elastic mode using the pressure value obtained in step S4;

S7. updating the structure motion and deformation by using dynamic information obtained in step S6, which in turn provides a new fluid boundary position;

S8. comparing structural position differences in step S2 and step S7, wherein if a convergence condition is satisfied, a next time step calculation is performed, otherwise, repeating steps S2 to S8 at a current time step until the next time step calculation is performed after the convergence condition is satisfied.

Specific steps of the step S1 are as follows:

In the MPS method, the gradient, divergence and Laplace operator of a physical quantity use the weighted average method, discretizing based on uniformly distributed particles, as shown in equation (1.1.1).

$$\begin{matrix}∇ φ ( {r}_{i} ) = \frac{{d}_{m}}{{n}_{0}} {\sum }_{j \neq i}^{N} \frac{φ ( {r}_{j} ) - φ ( {r}_{i} )}{{r}_{ij}^{2}} ( {r}_{j} - {r}_{i} ) W ( {r}_{ij} ) & ( 1 ) \\ {∇}^{2} φ ( {r}_{i} ) = \frac{2 {d}_{m}}{{n}_{0} λ} {\sum }_{j \neq i}^{N} [ φ ( {r}_{j} ) - φ ( {r}_{i} ) ] W ( {r}_{ij} ) & ( 2 ) ( 1.1 .1 ) \\ ∇ \cdot Φ ( {r}_{i} ) = \frac{{d}_{m}}{{n}_{0}} {\sum }_{j \neq i}^{N} \frac{( Φ ( {r}_{j} ) - Φ ( {r}_{i} ) ) \cdot ( {r}_{j} - {r}_{i} )}{{r}_{ij}^{2}} W ( {r}_{ij} ) & ( 3 )\end{matrix}$$

wherein, ϕ and Φ represent arbitrary scalars and vectors respectively, dₘ represents a number of dimensions of the problem under study: two dimensions or three dimensions, N is a number of particles in an affected area of the relevant particles; n₀ is a particle density at initial time, r represents a particle spacing, and rᵢ and rⱼ represent the coordinates of particle i and particle j respectively rᵢⱼ=|rᵢ−rⱼ|.

A kernel function W (rᵢⱼ) and a parameter λ are defined as equation (1.1.2) and equation (1.1.3):

$$\begin{matrix}W ( {r}_{ij} ) = \{ \begin{matrix}\frac{{r}_{e}}{{r}_{ij}} - 1 & 0 \leq {r}_{ij} \leq {r}_{e} \\ 0 & {r}_{ij} \geq {r}_{e}\end{matrix} & ( 1.1 .2 ) \\ λ = \frac{{\sum }_{j \neq i}^{N} W ( {r}_{ij} ) {r}_{ij}^{2}}{{\sum }_{j \neq i}^{N} W ( {r}_{ij} )} & ( 1.1 .3 )\end{matrix}$$

wherein, rₑ represents an effective range of particles interaction, and the particle density n is defined in equation (1.1.4):

$$n = {\sum }_{j \neq i}^{N} W ( {r}_{ij} ) \qquad ( 1.1 .4 )$$

In order to keep the particle distribution more regular and improve the stability and accuracy of the calculation, the technology of particle displacement shifting and collision processing (mainly for free surface particles) are adopted respectively. In this technique, the displacement of the particles is adjusted directly, rather than by applying a force. After each time step, the particle position is slightly displaced to make its distribution regular. This technique can also be considered as a grid reconstruction process. In addition, since the pressure Poisson equation is derived from the incompressibility condition, the resulting pressure will keep the distance between adjacent particles approximately at the same value (i.e., the initial particle distance r0).

An adjustment amount of the particle spacing as shown in equation (1.1.5):

$$δ {r}_{i} = {\sum }_{j \neq i} \frac{{r}_{0 -} \vert {r}_{ij} \vert}{2} \cdot \frac{{r}_{i -} {r}_{j}}{\vert {r}_{ij} \vert} , when \vert {r}_{ij} \vert \leq {r}_{0} \qquad ( 1.1 .5 )$$

wherein, r₀ is an initial particle spacing.

For free surface particles distal from a main fluid domain, when a relative velocity between the particles is closer than a threshold before a prediction step S3, performing an operation as shown in equation (1.1.6) to set the relative velocity of the particle pair δuᵢ to be zero;

$$δ {u}_{i} = {\sum }_{j \neq i} - □ ( {r}_{ij} ) {u}_{{τ}_{ij}} , when \vert {r}_{ij} - {u}_{{τ}_{ij}} Δ t \vert \leq {r}_{min} \vert , {r}_{min} = 0.3 {r}_{0} \qquad ( 1.1 .6 )$$

wherein, uᵣ_{ᵢⱼ} is a relative tangential velocity of particle i and particle j, and the adjacent particles of solid and fluid are taken as 0.5 and 1.0 respectively; Δt is a size of the time step.

Specific steps of the step S2 are as follows: introducing a variable A describing the motion and deformation of an object, which is defined as follows:

A=[X_{Rb},θ,q_{b}] (2.1.1)

wherein, X_{Rb} represents a position of a center of mass of a rigid body motion, θ represents a deadrise angle of the structure, and q_{b} represents general coordinates corresponding to a modal function.

The corresponding position, velocity and acceleration of the particles at an interface of the structure and the fluid are Γ_{fsi,0}^{k}, \dot{Γ}_{fsi,0}^{k} and \ddot{Γ}_{fsi,0}^{k}, wherein k represents a time step, a position where a subscript ‘0’ locates represents a number of iterations.

Estimating the position, velocity and acceleration of the current time step from the position, velocity and acceleration (that is, Γ_{fsi,0}^{k-1}, \dot{Γ}_{fsi,0}^{k-1} and \ddot{Γ}_{fsi,0}^{k-1}) of the structure boundary particles of the previous time step according to an assumption of uniform acceleration motion, and calculating an estimated value of the structural boundary position of the current time step based on the calculated position, velocity and acceleration of the current time step.

In the step 3, the Navier-Stokes equation is an incompressible and non-viscous Navier-Stokes equation based on a Lagrangian form, which is shown in equation (3.1.1):

$$\frac{Du}{Dt} = g - \frac{∇ p}{ρ} \qquad ( 3.1 .1 )$$

wherein, u, p and ρ represent the velocity, pressure and density of the fluid respectively, g is the vector pointing in a direction of gravity, and g represents the acceleration of gravity.

Specific steps of the step S3 are as follows:

Using a classic projection method to decouple the speed and pressure as follows:

Firstly, without considering the pressure, updating the liquid to an intermediate state only by inertia, as shown in equation (3.1.2):

u_{*}=uₖ+Δtg (1)

I_{*}=Iₖ+Δtu_{*} (2)(3.1.2)

wherein, l is a position vector, variables with subscripts * and k represent variables at an intermediate time step and a k^{th} time step respectively, and u represents the velocity of the fluid.

Specific steps of the step S4 are as follows:

Deriving the pressure Poisson equation by taking a divergence of the Navier-Stokes equation on both sides according to a continuity equation, as shown in equation (4.1.2), wherein, the continuity equation is shown in equation (4.1.1),

$$\begin{matrix}∇ \cdot u = 0 & ( 4.1 .1 ) \\ {∇}^{2} {p}_{k + 1} = \frac{ρ ∇ \cdot {u}_{*}}{Δ t} + αρ \frac{{n}_{0} - {n}_{k}}{{n}_{0} Δ {t}^{2}} & ( 4.1 .2 )\end{matrix}$$

wherein, n₀ and nₖ are the particle densities at the initial time and the k^{th} time step respectively, and the particle density is defined as shown in equation (1.1.4).

The coefficient α is defined as shown in (4.1.3):

$$α = \{ \begin{matrix}\vert \frac{{n}_{0} - {n}_{k}}{{n}_{0}} \vert + Δ t \vert ∇ \cdot {u}_{k} \vert & ( {n}_{0} - {n}_{k} ) ∇ \cdot {u}_{k} \geq 0 \\ \vert \frac{{n}_{0} - {n}_{k}}{{n}_{0}} \vert & ( {n}_{0} - {n}_{k} ) ∇ \cdot {u}_{k} \leq 0\end{matrix} \qquad ( 4.1 .3 )$$

The α model does not require special calibration for different problems, and has stronger stability than other similar models.

Boundary conditions for solving the pressure Poisson equation are as follows:

### (1) Solid Boundary Condition

Applying Neumann boundary conditions to solid particles, as shown in equation (4.1.4),

n·∇pₖ₊₁=ρ(n·g−n·\dot{u}_{b}_{ₖ₊₁})≅β(n·g−n·\dot{u}_{b}_{ₖ}) (4.1.4)

wherein, \dot{u}_{b}_{ₖ} and \dot{u}_{b}_{ₖ₊₁} the accelerations of the solid boundary particles at the k^{th} and (k+1)^{th} time steps; since \dot{u}_{b}_{ₖ₊₁} is unknown when solving the fluid motion at the (k+1)^{th} time step, the value \dot{u}_{b}_{ₖ} of the previous time step is used as an approximation.

Fluid particles proximal to the solid boundary need to be corrected for the Laplace operator, making it consistent with the Neumann boundary condition on the solid boundary, i.e. to make up for the deficiencies of adjacent particles. The pressure value for the virtual fluid particles outside the solid boundary is shown in equation (4.1.5); for near boundary fluid particles, the source term of the pressure Poisson equation also includes the role of solid boundary particles in the influence domain; therefore, due to the same consistency reasons, the intermediate velocity of the affected solid boundary particles is corrected as equation (4.1.6)-(1), which then are projected to tangential r and normal n directions respectively to obtain equations (4.1.6)-(2) and (4.1.6)-(3),

$$\begin{matrix}{p}_{v} = {p}_{s} + {ρ}_{0} ( n \cdot g - n \cdot {u}_{b} ) {r}_{0} & ( 4.1 .5 ) \\ {u}_{{b}^{*}} = {u}_{bk + 1} + Δ t \frac{∇ {p}_{k}}{{ρ}_{0}} & ( 1 ) \\ n \cdot {u}_{{b}^{*}} = n \cdot {u}_{bk + 1} + Δ t ( n \cdot g - n \cdot {\dot{u}}_{{b}_{k}} ) & ( 2 ) ( 4.1 .6 ) \\ τ \cdot {u}_{{b}^{*}} = τ \cdot {u}_{bk + 1} + \frac{Δ t}{{ρ}_{0}} \frac{\partial {p}_{k}}{\partial τ} & ( 3 )\end{matrix}$$

wherein, pᵥ represents an intensity of pressure of virtual particles, pₛ represents an intensity of pressure of responsive solid particles, u_{b*} and u_{b}_{ₖ₊₁} are the velocity of the solid boundary particles at the intermediate time and the (k+1)^{th} time step, and n in equations (4.1.5) and (4.1.6) represents a normal direction.

### (2) Free Surface Boundary Condition

Since solving the pressure Poisson equation requires applying a boundary condition with zero pressure on the free surface boundary, it is necessary to identify a position of the free surface particles:

For the case of two-dimensional cases, each particle is assigned a circle centered on itself with a radius of 1.05r₀, and the circle is discretized with 360 points evenly distributed on it; if all these points are covered by the circles of its neighboring particles, then the particle is an internal fluid particle, otherwise the particle is to be identified as a free surface particle; the inspection process is to identify the overlapping points on the arc (or patch in 3D case) covered by each adjacent particle by traversing each adjacent particle;

For the case of three-dimensional cases, a two-step method is used: firstly, checking a number of adjacent particles using equation (4.1.7) to detect potential free surface particles,

Nₚ<β_{3d}Nₚ₀ (4.1.7)

wherein, β_{3d} is a parameter less than 1, taking values according to situations, and Nₚ₀ represents a initial particle density within a delimited range.

Secondly, refining a search by establishing a spherical surface with a radius of 1.05r₀ centered on the particle, in detail: determining a vector pointing to the most sparse direction of a particle distribution around the particle by weighted average method, and discretizing a circular area on the spherical surface by uniformly distributed points, if all these points are covered by the spherical surface of its neighboring particles, the particle is an internal fluid particle, otherwise the particle will be identified as a free surface particle.

Calculation equation of step S5 is as shown in formula (5.1.1),

$${u}_{k + 1} = {u}_{*} - Δ t \cdot \frac{∇ {p}_{k + 1}}{{ρ}_{0}} \\ {r}_{k + 1} = {r}_{k} + Δ t \cdot {u}_{k + 1} \qquad ( 5.1 .1 )$$

The dynamic response of a typical ocean structure to wave impact can be expressed as a large rigid body motion and a small elastic deformation, which means that the modal superposition method can handle the elastic motion part. The present invention derives the time-domain model of the coupling rigid body and elastic modal based on the Lagrangian equation. The specific steps of step S6 are as follows:

S6.1. Establishment of Structural Motion Description Model

The structural motion description model uses a fixed global coordinate system XOY and an local coordinate system soη, wherein an origin of the attachment local coordinate system is selected at a center of gravity of a beam of the structural motion description model, thus a position X of any point on the beam of the structural motion description model can be described by equation (6.1.1):

X=X_{Rb}+Rξ^{T} (6.1.1)

wherein, X_{Rb} is a position of a center of mass of the beam of the structural motion description model, and equations (6.1.2) and (6.1.3) define local coordinates ξ of the beam of the structural motion description model and rotation matrix R of the beam of the structural motion description model,

$$\begin{matrix}ξ = [ s , {η}_{l} + {η}_{0} ] & ( 6.1 .2 ) \\ R = [ \begin{matrix}cos ( θ ) & - sin ( θ ) \\ sin ( θ ) & cos ( θ )\end{matrix} ] & ( 6.1 .3 )\end{matrix}$$

wherein, θ is an angle between O-X axis and o-s axis counterclockwise, η₁ is a coordinate of an undeformed structure, which is a constant for a specific point on the beam of the structural motion description model, and η₀ is a deflection of a mid-plane, the deflection of any plane parallel to the mid-plane taking the same value of the mid-plane; according to a modal superposition theory, the deflection η₀ of the mid-plane is expanded into equation (6.1.4):

η₀=φ^{T}q_{b} (6.1.4)

Equations (6.1.5) and (6.1.6) define a column vector φ of a modal function and corresponding general coordinates q_{b},

φ=[φ₁,φ₂,φ₃, . . . ]^{T} (6.1.5)

q_{b}=[q_{b1},q_{b2},q_{b3}, . . . ]^{T} (6.1.6)

The modal function satisfies the following orthogonal relationship:

$$\begin{matrix}{\int }_{{s}_{1}}^{{s}_{2}} {ϕρ}_{l} {ϕ}^{T} ds = {I}_{u} , {I}_{u} is an identity matrix & ( 6.1 .7 ) \\ {\int }_{{s}_{1}}^{{s}_{2}} \frac{{d}^{2} ϕ}{{ds}^{2}} {EI}_{I} \frac{{d}^{2} {ϕ}^{T}}{{ds}^{2}} ds = Λ , Λ = diag ( {ω}_{i}^{2} ) i = 1 , 2 , 3 , … & ( 6.1 .8 )\end{matrix}$$

wherein s₁ and s₂ are upper and lower limits integrated along o-s axis, ρ₁ is an line density of the beam of the structural motion description model, E represents an elastic modulus of a structure, and I_{I} is an inertia matrix of the structure;

S6.2. Establishment of the Governing Equation of Solid Response Based on Lagrange Equation

The main feature of the modal superposition method model is that the rigid body modal and the elastic modal are coupled in the time domain. The effects of interactions such as inertial effects of rigid body motion on elastic deformation are considered. This is an extension of the traditional hydroelastic theory. In the traditional hydroelastic theory, rigid body and elastic part are only connected by the corresponding cross-term hydrodynamic coefficient.

Establishing a model based on Lagrange equation:

$$\frac{d}{dt} ( \frac{\partial T}{\partial {\dot{q}}_{j}} ) + \frac{\partial U}{\partial {q}_{j}} - \frac{\partial T}{\partial {q}_{j}} = {Q}_{j} j = 1 , 2 , 3 , … \qquad ( 6.2 .1 )$$

wherein T and U represent an kinetic energy and potential energy of the structural motion description model, qⱼ is a general coordinate corresponding to any rigid-flexible mode, and Qⱼ is a non-conservative force corresponding to the j^{th} coordinate.

The beam of the structural motion description model is an elastic non-uniform beam, and specific forms of T, U, qⱼ, Qⱼ of the elastic non-uniform beam are as follows:

$$\begin{matrix}\begin{matrix}T = & \frac{1}{2} {\int }_{{s}_{1}}^{{s}_{2}} {\int }_{{η}_{1}}^{{η}_{2}} {\dot{X}}^{T} {ρ}_{s} \dot{X} d η ds = \\ & \frac{1}{2} {\int }_{{s}_{1}}^{{s}_{2}} {\int }_{{η}_{1}}^{{η}_{2}} {( {\dot{X}}_{R} + RU \dot{θ} ξ + R \dot{ξ} )}^{T} {ρ}_{s} ( {\dot{X}}_{R} + RU \dot{θ} ξ + R \dot{ξ} ) d η ds \\ = & \frac{1}{2} [ M ( {\dot{X}}_{R}^{2} + {\dot{Y}}_{R}^{2} ) + {\dot{θ}}^{2} {I}_{b} + {\dot{θ}}^{2} {q}_{b}^{T} {q}_{b} + {\dot{q}}_{b}^{T} {\dot{q}}_{b} - \\ & 2 \dot{θ} ( {\dot{X}}_{R} cos ( θ ) + {\dot{Y}}_{R} sin ( θ ) ) {q}_{b}^{T} {ψ}_{0} + \\ & 2 ( - {\dot{X}}_{R} sin ( θ ) + {\dot{Y}}_{R} cos ( θ ) ) {\dot{q}}_{b}^{T} {ψ}_{0} + 2 \dot{θ} {\dot{q}}_{b}^{T} {ψ}_{1} ]\end{matrix} & ( 6.2 .2 ) \\ \begin{matrix}U = & \frac{1}{2} {\int }_{{s}_{1}}^{{s}_{2}} \frac{{d}^{2} {η}_{0}}{{ds}^{2}} EI \frac{{d}^{2} {η}_{0}}{{ds}^{2}} ds + {MgY}_{R} \\ = & \frac{1}{2} {q}_{b}^{T} ( {\int }_{{s}_{1}}^{{s}_{2}} \frac{{d}^{2} ϕ}{{ds}^{2}} EI \frac{{d}^{2} {ϕ}^{T}}{{ds}^{2}} ds ) {q}_{b} + \\ & {MgY}_{R} = \frac{1}{2} {q}_{b}^{T} Λ {q}_{b} + {MgY}_{R}\end{matrix} & ( 6.2 .3 )\end{matrix}$$

wherein ρₛ represents a linear density, M represents mass of a structure, X_{R} and Y_{R} correspond to X and Y coordinates of a center of mass of the structure respectively, g represents the acceleration of gravity, η₁ and η₂ are the upper and lower limits of integral along axis η, matrix integral U and column vector integrals Ψ₀ and ψ₁, the matrix integral U and column vector integrals Ψ₀, Ψ₁ defined in equations (6.2.4) and (6.2.6):

$$\begin{matrix}U = [ \begin{matrix}0 & - 1 \\ 1 & 0\end{matrix} ] & ( 6.2 .4 ) \\ {ψ}_{0} = {[ {ψ}_{01} , {ψ}_{02} , {ψ}_{03} , … ]}^{T} = {\int }_{{s}_{1}}^{{s}_{2}} {ϕρ}_{l} ds & ( 6.2 .5 ) \\ {ψ}_{1} = {[ {ψ}_{11} , {ψ}_{12} , {ψ}_{13} , … ]}^{T} = {\int }_{{s}_{1}}^{{s}_{2}} s {ϕρ}_{l} ds & ( 6.2 .6 )\end{matrix}$$

The governing equations of the dynamic response for elastic non-uniform beam under a wave impact can be obtained by substituting equations (6.2.2) and (6.2.3) into equation (6.2.1), which is shown in equation (6.2.7):

M\ddot{X}_{Rb}+\dot{θ}² sin(θ)ψ₀^{T}q_{b}−2\dot{θ} cos(θ)Ψ₀^{T}\dot{q}_{b}−\ddot{θ} cos(θ)Ψ₀^{T}q_{b}−sin(θ)Ψ₀^{T}\ddot{q}_{b}=Q_{X}_{_{Rb}}

MŸ_{Rb}−\dot{θ}² cos(θ)ψ₀^{T}q_{b}−2\dot{θ} sin(θ)ψ₀^{T}\dot{q}_{b}−\ddot{θ} sin(θ)ψ₀^{T}q_{b}+cos(θ)ψ₀^{T}\ddot{q}_{b}+Mg=Q_{Y}_{_{Rb}}

−(\ddot{X}_{Rb} cos(θ)+Ÿ_{Rb} sin(θ))ψ₀^{T}q_{b}+I_{b}\ddot{θ}+\ddot{θ}q_{b}^{T}q_{b}+2\dot{θ}\dot{q}_{b}^{T}q_{b}+ψ₁^{T}\ddot{q}_{b}=Q_{θ}

(−\ddot{X}_{Rb} sin(θ)+Ÿ_{Rb} cos(θ))ψ₀+\ddot{θ}ψ₁+\ddot{q}_{b}+Λq_{b}−\dot{θ}²q_{b}=Q_{q}_{_{b}} (6.2.7)

Equations (6.2.8)-(6.2.11) provide the non-conservative forces corresponding to the general coordinates of the rigid body and the elastic modal:

Q_{X}_{_{Rb}}= [symbol] pnₛdl (6.2.8)

Q_{Y}_{_{Rb}}= [symbol] pn_{η}dl (6.2.9)

Q_{θ}= [symbol] p(Xₚnₚ−Yₚnₛ)dl (6.2.10)

Q_{q}_{_{b}}= [symbol] p(n·e_{η})φdl (6.2.11)

wherein, nₛ and n_{η} are local normal components of s and η respectively, expressed by a fixed global coordinate system, Xₚ and Yₚ are overall X and Y coordinates of a point of action of an intensity of pressure p, e_{η} is an unit vector of O-η axis, and the integration is carried out around a perimeter of the beam of the structural motion description model; and it can be seen from equation (6.2.7) that the interaction between the rigid body and the elastic mode, i.e. the cross term, is caused by angular motion.

S6.3. Solving the Governing Equation of Solid Response which Couples the Rigid Body and Elastic Mode.

For the interaction process of fluid and structure, standard iteration method is used until certain criteria are met.

Specific steps of the step S8 are as follows:

Assuming that all fluid and structural variables are known in time step t=tₖ₋₁, and then the detailed interaction process at the next time t=tₖ is as follows:

S8.1. assuming that an acceleration of a structure at the time step t=tₖ is the same as the acceleration at the previous time step t=tₖ₋₁, that is, \ddot{D}^{k}=\ddot{D}^{k-1}, a position D^{k} and speed \dot{D}^{k} at the time step t=tₖ can also be calculated by a finite difference method.

Calculating the corresponding position, velocity and acceleration of each point on the interface between fluid and structure through equations (8.1.1)˜(8.1.6), that is, Γ_{fsi,0}^{(k)}, \dot{Γ}_{fsi,0}^{(k)} and \ddot{Γ}_{fsi,0}^{(k)} can be calculated from the newly calculated structural motion and deformation parameters A, that is, equation (2.1.1),

$$\begin{matrix} {X}_{R} = {X}_{CR} + {R}_{{RX}_{R}} & ( 8.1 .1 ) \\ {X}_{fi} = {X}_{cfi} + {R}_{fi} {ξ}_{i}^{T} & ( 8.1 .2 ) \\ {\dot{X}}_{R} = {\dot{X}}_{CR} + {\dot{R}}_{{RX}_{R}} = {\dot{X}}_{C} R + {\dot{R}}_{R} U {\dot{θ}}_{R} {χ}_{R} & ( 8.1 .3 ) \\ {\dot{X}}_{fi} = {\dot{X}}_{cR} + {\dot{R}}_{R} {χ}_{ofi} + {\dot{R}}_{fi} {ξ}_{i}^{T} + {\dot{R}}_{fi} {ξ}_{i}^{T} = {\dot{X}}_{CR} + {R}_{R} U {\dot{θ}}_{R} {χ}_{ofi} + {R}_{fi} U {\dot{θ}}_{fi} {χ}_{ofi} {ξ}_{i} + {R}_{fi} {\dot{ξ}}_{i} & ( 8.1 .4 ) \\ {\ddot{X}}_{R} = {\ddot{X}}_{CR} + {\ddot{R}}_{R} {χ}_{R} = {\ddot{X}}_{R} + ( {R}_{R} U {\ddot{θ}}_{R} - {R}_{R} {\ddot{θ}}_{R}^{2} ) {χ}_{R} & ( 8.1 .5 ) \\ \begin{matrix}{\ddot{X}}_{fi} = & {\ddot{X}}_{CR} + {\ddot{R}}_{R} {χ}_{ofi} + {\ddot{R}}_{fi} {ξ}_{i} + 2 {\dot{R}}_{fi} {\dot{ξ}}_{i} + {R}_{fi} {\ddot{ξ}}_{i} \\ = & {\ddot{X}}_{CR} + ( {R}_{R} U {\ddot{θ}}_{R} - {R}_{R} {\ddot{θ}}_{R}^{2} ) {χ}_{ofi} + \\ & ( {R}_{fi} U {\ddot{θ}}_{fi} - {R}_{fi} {\ddot{θ}}_{fi}^{2} ) {ξ}_{i} + 2 {R}_{fi} U {\ddot{θ}}_{fi} {\dot{ξ}}_{i} + {R}_{fi} {\ddot{ξ}}_{i}\end{matrix} & ( 8.1 .6 )\end{matrix}$$

wherein, X_{R} is global coordinates of rigid body, X_{CR} is a center-of-mass coordinates, R_{R} is a rotation matrix that associates the local coordinate system soη with the fixed global coordinate system XOY; X_{fi} represents the coordinates on a center line; and ξᵢ represents the coordinates of the beam center line of in the local coordinate system soη, as represented in equation (8.1.7), wherein ηᵢ is deflection function of the beam;

ξᵢ=[sᵢ,ηᵢ] (8.1.7)

S8.2. calculating the fluid motion at time t=tₖ according to the modified MPS method by using updated information of the interface as a new boundary condition, by using the newly updated pressure p_{fsi,i+1}^{k}, the i^{th} iteration of the interface at time t=tₖ can be conducted;

S8.3. comparing structural position differences Γ_{fsi,i}^{k} and \tilde{Γ}_{fsi,i+1}^{k} in step S2 and step S7, if a convergence condition is satisfied, as shown in equation (8.3.1), performing step S8.1 for the next time step t=tₖ₊₁ operation,

$$\vert {\tilde{Γ}}_{fsi , i + 1}^{k} - {Γ}_{fsi , i}^{k} \vert \leq ϵ \qquad ( 8.3 .1 )$$

Otherwise using equation (8.3.2) to correct the structural position Dᵢ₊₁^{k} of the (i+1)^{th} iteration, and using Newmark method to update velocity \dot{D}ᵢ₊₁^{k} and acceleration \ddot{D}ᵢ₊₁^{k}, calculating interface variables Γ_{fsi,i+1}^{k}, \dot{Γ}_{fsi,i+1}^{k} and \ddot{Γ}_{fsi,i+1}^{k}, based on Dᵢ₊₁^{k}, \dot{D}ᵢ₊₁^{k} and \ddot{D}ᵢ₊₁^{k}; using these modified interface variables to perform the (i+1)^{th} iteration by returning to step S2,

Dᵢ₊₁^{k}=\tilde{D}ᵢ₊₁^{k}+(1−χᵢ)Dᵢ^{k} (8.3.2)

wherein, χᵢ is Aitken relaxation factor, a core idea of which is to improve the accuracy of prediction by using the first two iterations.

λᵢ is calculated by equation (8.3.3):

$${χ}_{i} = - {χ}_{i - 1} \frac{{( {ΔΓ}_{fsi , i}^{k} )}^{T} ( {ΔΓ}_{fsi , i + 1}^{k} - {ΔΓ}_{fsi , i}^{k} )}{{( {ΔΓ}_{fsi , i + 1}^{k} - {ΔΓ}_{fsi , i}^{k} )}^{T} ( {ΔΓ}_{fsi , i + 1}^{k} - {ΔΓ}_{fsi , i}^{k} )} \qquad ( 8.3 .3 )$$

wherein, Γ_{fsi,i}^{k}=\tilde{Γ}_{fsi,i}^{k}−Γ_{fsi,i-1}^{k}.

Disclosed is a method for analyzing hydroelastic effect of a marine structure base on a moving particle semi-implicit method and a modal superposition method. The method is based on a fluid dynamic solver of a moving particle semi-implicit method (MPS) and a structural response solver of a mode superposition method based on a coupling rigid body and an elastic modal, and the fluid dynamic solver and the structural response solver achieve strong coupling in a time domain in an iterative manner. According to the present disclosure, the deficiency that the traditional potential flow-based hydroelesticity calculation cannot directly simulate the severe deformation of the free surface and the slamming phenomenon of the ship body is improved, and the problem of mutual influence between the rigidity of the structure and the flexible motion modal is considered.

### BRIEF DESCRIPTION OF THE DRAWINGS

In order to more clearly explain the embodiments of the present invention or the technical solutions in the prior art, the drawings required in the description of the embodiments or the prior art will be briefly introduced below. Obviously, the drawings in the following descriptions are some embodiments of the present invention. For those of ordinary skill in the art, without inventive effort, other drawings can be obtained based on these drawings.

FIG. 1 is two-dimensional and three-dimensional free surface particle recognition schemes.

FIG. 2 is a schematic diagram of an elastic non-uniform beam.

FIG. 3 is a schematic diagram of the initial configuration of the calculation (not to scale).

FIG. 4 is a cross-sectional and surface discretization diagram of a ship model.

FIG. 5 shows the distribution of the mass (a) and second moment (b) of the ship model.

FIG. 6 shows the first three modes of the ship model.

FIG. 7 is a typical time step free surface shape and ship deformation diagram ((a) t=0.1s, (b) t=0.2s, (c) t=0.418s, (d) t=0.684s, (e) t=0.91s, (f) t=1.05s).

FIG. 8 is a demonstration of the Laplace operator used to compensate for virtual particles near the solid boundary.

FIG. 9 is a flow chart of the iterative process of interaction between fluid and structure.

### DESCRIPTION OF THE EMBODIMENTS

To make the objectives, technical solutions, and advantages of the embodiments of the present invention clearer, the technical solutions in the embodiments of the present invention will be described clearly and completely in conjunction with the drawings in the embodiments of the present invention. Obviously, the described embodiments are parts of the embodiments of the present invention, but not all the embodiments. Based on the embodiments of the present invention, all the other embodiments obtained by those of ordinary skill in the art without inventive effort are within the scope of the present invention.

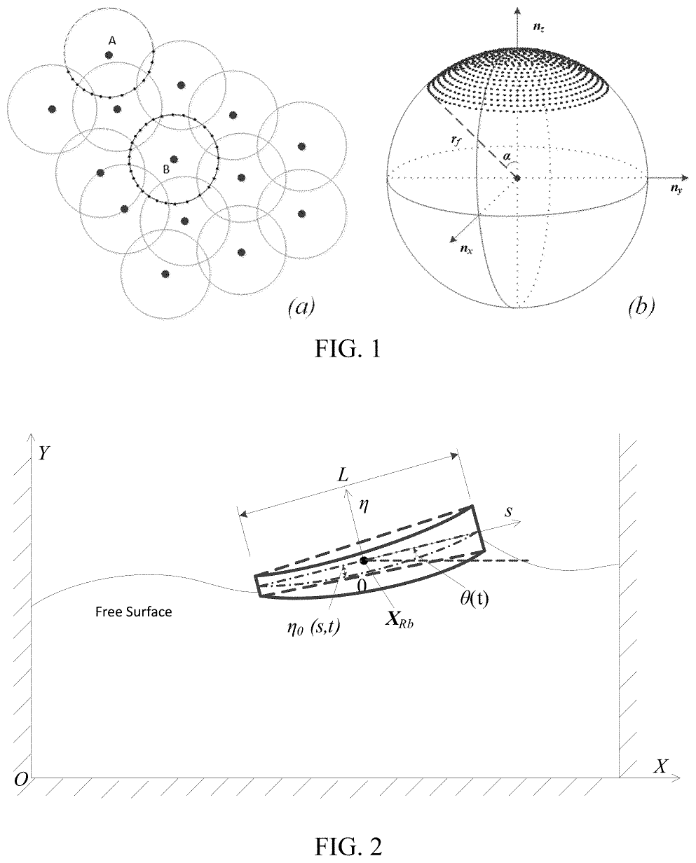

As shown in FIGS. 1-9, disclosed is a method for analyzing hydroelastic effect of a marine structure based on a moving particle semi-implicit method and a modal superposition method, and in the time domain, the solutions are decomposed into a number of time intervals with small intervals. Assuming that the information of the flow field and structural motion in the previous time step (or initial moment) is known, the following calculation is performed on the current time step, including the following steps:

S1. spatially discretizing the boundary of the flow field with mesh-less discrete points to avoid the difficulty of re-meshing caused by strong nonlinear free surface motion and large rigid body displacement of the structure, wherein if a previous time step is initial time, velocity and intensity of pressure of fluid particles need to be initialized;

S2. determining an estimated value of a structural boundary position of a current time step according to motion information of a solid boundary of the previous time step, wherein if the previous time step is the initial time, an initial value of a structural motion is adopted;

S3. updating a position and a velocity of fluid particles by Navier-Stokes equation according to flow field information of the previous time step, excluding fluid pressure;

S4. deriving a pressure Poisson equation and solving the pressure Poisson equation;

S5. updating the position and the velocity of the fluid particles using the pressure value obtained in S4;

S6. solving the governing equation of solid response using the pressure value obtained in step S4;

S7. updating the structure motion and deformation by using dynamic information obtained in step S6, which in turn provides the new fluid boundary position;

S8. comparing structural position differences in step S2 and step S7, wherein if a convergence condition is satisfied, a next time step calculation is performed, otherwise, repeating steps S2 to S8 at the current time step until the next time step calculation is performed after the convergence condition is satisfied.

Steps S1-S4 are part of the hydrodynamic solver (modified MPS method), and step S6 is a structural response solver.

Specific steps of the step S1 are as follows: discretizing based on uniformly distributed particles, as shown in equation (1.1.1).

$$\begin{matrix}∇ φ = \frac{{d}_{m}}{{n}_{0}} {\sum }_{j \neq i}^{N} \frac{φ ( {r}_{j} ) - φ ( {r}_{i} )}{{r}_{ij}^{2}} ( {r}_{j} - {r}_{i} ) W ( {r}_{ij} ) & ( 1 ) \\ {∇}^{2} φ ( {r}_{i} ) = \frac{2 {d}_{m}}{{n}_{0} λ} {\sum }_{j \neq i}^{N} [ φ ( {r}_{j} ) - φ ( {r}_{i} ) ] W ( {r}_{ij} ) & ( 2 ) ( 1.1 .1 ) \\ ∇ \cdot Φ ( {r}_{i} ) = \frac{{d}_{m}}{{n}_{0}} {\sum }_{j \neq i}^{N} \frac{( Φ ( {r}_{j} ) - Φ ( {r}_{i} ) ) \cdot ( {r}_{j} - {r}_{i} )}{{r}_{ij}^{2}} W ( {r}_{ij} ) & ( 3 )\end{matrix}$$

wherein, ϕ and Φ represent arbitrary scalars and vectors respectively, dₘ represents a number of dimensions of the problem under study: two dimensions or three dimensions, N is a number of particles in an affected area of the relevant particles; no is a particle density at initial time; gradient/divergence and the radius of Laplace operator rₑ are 2.1r₀ and 4.0r₀, r₀ is an initial particle spacing; n₀ is the particle density at the initial moment.

A kernel function W (rᵢⱼ) and a parameter λ are defined as equation (1.1.2) and equation (1.1.3): an adjustment amount of the particle spacing as shown in equation (1.1.5):

$$\begin{matrix}W ( {r}_{ij} ) = \{ \begin{matrix}\frac{{r}_{e}}{{r}_{ij}} - 1 & 0 \leq {r}_{ij} \leq {r}_{e} \\ 0 & {r}_{ij} \geq {r}_{e}\end{matrix} & ( 1.1 .2 ) \\ λ = \frac{{\sum }_{j \neq i}^{N} W ( {r}_{ij} ) {r}_{ij}^{2}}{{\sum }_{j \neq i}^{N} W ( {r}_{ij} )} & ( 1.1 .3 )\end{matrix}$$

the particle density is defined in equation (1.1.4):

$$n = {\sum }_{j \neq i}^{N} W ( {r}_{ij} ) \qquad ( 1.1 .4 )$$

an adjustment amount of the particle spacing as shown in equation (1.1.5):

$$δ {r}_{i} = {\sum }_{j \neq i} \frac{{r}_{0 -} \vert {r}_{ij} \vert}{2} \cdot \frac{{r}_{i -} {r}_{j}}{\vert {r}_{ij} \vert} , when \vert {r}_{ij} \vert \leq {r}_{0} \qquad ( 1.1 .5 )$$

For the free surface particles distal from a main fluid domain, when a relative velocity between the particles is closer than a threshold before a prediction step, performing an operation as shown in equation (1.1.6) to set the relative velocity of the particle pair to be zero;

$$δ {u}_{i} = {\sum }_{j \neq i} - □ ( {r}_{ij} ) {u}_{{τ}_{ij}} , when \vert {r}_{ij} - {u}_{{τ}_{ij}} Δ t \vert \leq {r}_{min} \vert , {r}_{min} = 0.3 {r}_{0} \qquad ( 1.1 .6 )$$

wherein, uᵣ_{ᵢⱼ} is a relative tangential velocity of particle i and particle j, and the adjacent particles of solid and fluid are taken as 0.5 and 1.0 respectively.

Specific steps of the step S2 are as follows:

Introducing a variable A describing the motion and deformation of an object, which is defined as follows:

A=[X_{Rb},θ,q_{b}] (2.1.1)

The corresponding position, velocity and acceleration of the particles at an interface of the structure and the fluid are Γ_{fsi,0}^{k}, \dot{Γ}_{fsi,0}^{k} and \ddot{Γ}_{fsi,0}^{k}, wherein k represents a time step, a position where a subscript ‘0’ locates represents a number of iterations.

Estimating the position, velocity and acceleration of the current time step from the position Γ_{fsi,0}^{k-1}, velocity \dot{Γ}_{fsi,0}^{k-1} and acceleration \ddot{Γ}_{fsi,0}^{k-1} of the structure boundary particles of the previous time step according to an assumption of uniform acceleration motion, and calculating the estimated value of the structural boundary position of the current time step based on the calculated position, velocity and acceleration of the current time step.

The Lagrangian form non-viscous Navier-Stokes equation is shown in equation (3.1.1):

$$\frac{Du}{Dt} = g - \frac{∇ p}{ρ} \qquad ( 3.1 .1 )$$

wherein, u, p and ρ represent the velocity, pressure and density of the fluid respectively, which are all vectors pointing in a direction of gravity, and g is the acceleration of gravity.

Specific steps of the step S3 are as follows:

Firstly, using a classic projection method to decouple the speed and pressure as follows: without considering the pressure, updating the liquid to an intermediate state only by inertia, as shown in equation (3.1.2):

u_{*}=uₖ+Δtg (1)

l_{*}=lₖ+Δtu_{*} (2)(3.1.2)

wherein, l is a position vector, variables with subscripts * and k represent variables at an intermediate time step and a k^{th} time step respectively.

Specific steps of the step S4 are as follows:

Deriving the pressure Poisson equation by taking a divergence of the Navier-Stokes equation on both sides according to a continuity equation, as shown in (4.1.2), wherein, the continuity equation is shown in equation (4.1.1),

$$\begin{matrix}∇ \cdot u = 0 & ( 4.1 .1 ) \\ {∇}^{2} {p}_{k + 1} = \frac{ρ ∇ \cdot {u}_{*}}{Δ t} + αρ \frac{{n}_{0} - {n}_{k}}{{n}_{0} Δ {t}^{2}} & ( 4.1 .2 )\end{matrix}$$

wherein, n₀ and nₖ are the particle densities at the initial time and the k^{th} time step respectively, and the particle density is defined as shown in equation (1.1.4).

The coefficient α is defined as shown in (4.1.3):

$$α = \{ \begin{matrix}\vert \frac{{n}_{0} - {n}_{k}}{{n}_{0}} \vert + Δ t \vert ∇ \cdot {u}_{k} \vert & ( {n}_{0} - {n}_{k} ) ∇ \cdot {u}_{k} \geq 0 \\ \vert \frac{{n}_{0} - {n}_{k}}{{n}_{0}} \vert & ( {n}_{0} - {n}_{k} ) ∇ \cdot {u}_{k} \leq 0\end{matrix} \qquad ( 4.1 .3 )$$

Boundary conditions for solving the pressure Poisson equation are as follows:

### (1) Solid Boundary Conditions

Applying Neumann boundary conditions to solid particles, as shown in equation (4.1.4),

n·∇pₖ₊₁=ρ(n·g−n·\dot{u}_{b}_{ₖ₊₁})≈ρ(n·g−n·\dot{u}_{b}_{ₖ}) (4.1.4)

wherein, \dot{u}_{b}_{ₖ} and \dot{u}_{b}_{ₖ₊₁} the accelerations of the solid boundary particles at the k^{th} and (k+1)^{th} time steps; since \dot{u}_{b}_{ₖ₊₁} is unknown when solving the fluid motion at the (k+1)^{th} time step, the value \dot{u}_{b}_{ₖ} of the previous time step is used as an approximation.

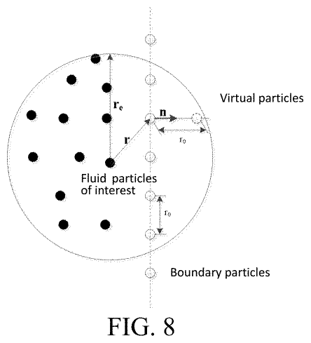

As shown in FIG. 8, fluid particles proximal to the solid boundary need to be corrected for the Laplace operator, wherein a pressure value is shown in equation (4.1.5), and a discrete term in equation (1.1.1) is corrected to make it consistent with equation (4.1.2); an intermediate velocity of the affected solid boundary particles is corrected as equation (4.1.6)-(1), which then are projected to tangential τ and normal n directions respectively to obtain equations (4.1.6)-(2) and (4.1.6)-(3),

$$\begin{matrix}{p}_{v} = {p}_{s} + {ρ}_{0} ( n \cdot g - n \cdot {\dot{u}}_{b} ) {r}_{0} & ( 4.1 .5 ) \\ {u}_{{b}^{*}} = {u}_{bk + 1} + Δ t \frac{∇ {p}_{k}}{{ρ}_{0}} & ( 1 ) \\ n \cdot {u}_{{b}^{*}} = n \cdot {u}_{bk + 1} + Δ t ( n \cdot g - n \cdot {\dot{u}}_{{b}_{k}} ) & ( 2 ) ( 4.1 .6 ) \\ τ \cdot {u}_{{b}^{*}} = τ \cdot {u}_{bk + 1} + \frac{Δ t}{{ρ}_{0}} \frac{\partial {p}_{k}}{\partial τ} & ( 3 )\end{matrix}$$

wherein, u_{b*} and u_{b}_{ₖ₊₁} are the velocity of the solid boundary particles at the intermediate time and the (k+1)^{th} time step.

### (2) Free Surface Boundary Condition

Since solving the pressure Poisson equation requires applying a boundary condition with zero pressure on the free surface boundary, it is necessary to identify a position of the free surface particles: for the case of two dimensions, each particle is assigned a circle centered on itself, with a radius of 1.05r₀, and discretized with 360 points evenly distributed on the circle; if all these points are covered by the circles of its neighboring particles, then the particle is an internal fluid particle (particle B in FIG. 1(a)), otherwise the particle is to be identified as a free surface particle (particle A in FIG. 1(a));

for the case of three dimensions, a two-step method is used: firstly, checking a number of adjacent particles using equation (4.1.7) to detect potential free surface particles,

Nₚ<δ_{3d}Nₚ₀ (4.1.7)

in this embodiment, Nₚ₀=32, β_{3d}=0.96.

Secondly, refining a search by establishing a spherical surface centered on the particle and having a radius of 1.05r₀. More specifically, finding the vector pointing to the most sparsely distributed direction of surrounding particles around the concerned particle by weighted average method, as shown in FIG. 1(b), and discretizing a circular area on the spherical surface by uniformly distributed points, if all these points are covered by the spherical surface of its neighboring particles, the particle is an internal fluid particle, otherwise the particle will be identified as a free surface particle.

Calculation equation of step S5 is as shown in equation (5.1.1),

$${u}_{k + 1} = {u}_{*} - Δ t \cdot \frac{∇ {p}_{k + 1}}{{ρ}_{0}} \\ {r}_{k + 1} = {r}_{k} + Δ t \cdot {u}_{k + 1} \qquad ( 5.1 .1 )$$

Specific steps of the step S6 are as follows:

S6.1. Establishment of Structural Motion Description Model

The structural motion description model uses a fixed global coordinate system XOY and an local coordinate system soη, wherein an origin of the local coordinate system is selected at a center of gravity of a beam of the structural motion description model, thus a position of any point on the beam of the structural motion description model can be described by equation (6.1.1), schematic diagram shown in FIG. 2.

X=X_{Rb}+Rξ^{T} (6.1.1)

wherein, X_{Rb} is a position of a center of mass, and equations (6.1.2) and (6.1.3) define local coordinates ξ of the beam of the structural motion description model and rotation matrix R of the beam of the structural motion description model,

$$\begin{matrix}ξ = [ s , {η}_{l} + {η}_{0} ] & ( 6.1 .2 ) \\ R = [ \begin{matrix}cos ( θ ) & - sin ( θ ) \\ sin ( θ ) & cos ( θ )\end{matrix} ] & ( 6.1 .3 )\end{matrix}$$

wherein, θ is an angle between O-X axis and o-s axis counterclockwise, η₁ is a coordinate of an undeformed structure, which is a constant for a specific point on the beam of the structural motion description model, and η₀ is a deflection of a mid-plane, the deflection of any plane parallel to the mid-plane taking the same value of the mid-plane; according to a modal superposition theory, the deflection η₀ of the mid-plane is expanded into equation (6.1.4).

Equations (6.1.5) and (6.1.6) define a column vector φ of a modal function and corresponding general coordinates q_{b},

φ=[φ₁,φ₂,φ₃, . . . ]^{T} (6.1.5)

q_{b}=[q_{b1},q_{b2},q_{b3}, . . . ]^{T} (6.1.6)

The modal function satisfies the following orthogonal relationship:

$$\begin{matrix}{\int }_{{s}_{1}}^{{s}_{2}} {ϕρ}_{l} {ϕ}^{T} ds = {I}_{u} , {I}_{u} is an identity matrix & ( 6.1 .7 ) \\ {\int }_{{s}_{1}}^{{s}_{2}} \frac{{d}^{2} ϕ}{{ds}^{2}} EI \frac{{d}^{2} {ϕ}^{T}}{{ds}^{2}} ds = Λ , Λ = diag ( {ω}_{i}^{2} ) i = 1 , 2 , 3 , … & ( 6.1 .8 )\end{matrix}$$

wherein s₁ and s₂ are upper and lower limits integrated along o-s axis, ρ₁ is an line density of the beam of the structural motion description model, E represents an elastic modulus of a structure, and I₁ is an inertia matrix of the structure;

S6.2. Establishment of the Governing Equation of Solid Response Based on Lagrange Equation

Establishing a model based on Lagrange equation:

$$\frac{d}{dt} ( \frac{\partial T}{\partial {\dot{q}}_{j}} ) + \frac{\partial U}{\partial {q}_{j}} - \frac{\partial T}{\partial {q}_{j}} = {Q}_{j} j = 1 , 2 , 3 , … \qquad ( 6.2 .1 )$$

wherein T and U represent an kinetic energy and an potential energy of the structural motion description model, qⱼ is a general coordinate corresponding to any rigid-flexible mode, and Qⱼ is a non-conservative force corresponding to the j^{th} coordinate.

The beam of the structural motion description model is an elastic non-uniform beam, and specific forms of T, U, qⱼ, Qⱼ of the elastic non-uniform beam are as follows:

$$\begin{matrix}\begin{matrix}T = & \frac{1}{2} {\int }_{{s}_{1}}^{{s}_{2}} {\int }_{{η}_{1}}^{{η}_{2}} {\dot{X}}^{T} {ρ}_{s} \dot{X} d η ds = \\ & \frac{1}{2} {\int }_{{s}_{1}}^{{s}_{2}} {\int }_{{η}_{1}}^{{η}_{2}} {( {\dot{X}}_{R} + RU \dot{θ} ξ + R \dot{ξ} )}^{T} {ρ}_{s} ( {\dot{X}}_{R} + RU \dot{θ} ξ + R \dot{ξ} ) d η ds \\ = & \frac{1}{2} [ M ( {\dot{X}}_{R}^{2} + {\dot{Y}}_{R}^{2} ) + {\dot{θ}}^{2} {I}_{b} + {\dot{θ}}^{2} {q}_{b}^{T} {q}_{b} + {\dot{q}}_{b}^{T} {\dot{q}}_{b} - \\ & 2 \dot{θ} ( {\dot{X}}_{R} cos ( θ ) + {\dot{Y}}_{R} sin ( θ ) ) {q}_{b}^{T} {ψ}_{0} + \\ & 2 ( - {\dot{X}}_{R} sin ( θ ) + {\dot{Y}}_{R} cos ( θ ) ) {\dot{q}}_{b}^{T} {ψ}_{0} + 2 \dot{θ} {\dot{q}}_{b}^{T} {ψ}_{1} ]\end{matrix} & ( 6.2 .2 ) \\ \begin{matrix}U = & \frac{1}{2} {\int }_{{s}_{1}}^{{s}_{2}} \frac{{d}^{2} {η}_{0}}{{ds}^{2}} EI \frac{{d}^{2} {η}_{0}}{{ds}^{2}} ds + {MgY}_{R} \\ = & \frac{1}{2} {q}_{b}^{T} ( {\int }_{{s}_{1}}^{{s}_{2}} \frac{{d}^{2} ϕ}{{ds}^{2}} EI \frac{{d}^{2} {ϕ}^{T}}{{ds}^{2}} ds ) {q}_{b} + \\ & {MgY}_{R} = \frac{1}{2} {q}_{b}^{T} Λ {q}_{b} + {MgY}_{R}\end{matrix} & ( 6.2 .3 )\end{matrix}$$

wherein η₁ and η₂ are the upper and lower limits of integral along axis η, matrix integral U, column vector integrals Ψ₀ and Ψ₁, the matrix integral U and column vector integrals Ψ₀, Ψ₁ defined in equations (6.2.4) and (6.2.6):

$$\begin{matrix}U = [ \begin{matrix}0 & - 1 \\ 1 & 0\end{matrix} ] & ( 6.2 .4 ) \\ {ψ}_{0} = {[ {ψ}_{01} , {ψ}_{02} , {ψ}_{03} , … ]}^{T} = {\int }_{{s}_{1}}^{{s}_{2}} {ϕρ}_{l} ds & ( 6.2 .5 ) \\ {ψ}_{1} = {[ {ψ}_{11} , {ψ}_{12} , {ψ}_{13} , … ]}^{T} = {\int }_{{s}_{1}}^{{s}_{2}} s {ϕρ}_{l} ds & ( 6.2 .6 )\end{matrix}$$

The governing equations of the dynamic response for elastic non-uniform beam under a wave impact can be obtained by substituting equations (6.2.2) and (6.2.3) into equation (6.2.1), which is shown in equation (6.2.7):

M\ddot{X}_{Rb}+\dot{θ}² sin(θ)ψ₀^{T}q_{b}−2\dot{θ} cos(θ)Ψ₀^{T}\dot{q}_{b}−\ddot{θ} cos(θ)Ψ₀^{T}q_{b}−sin(θ)Ψ₀^{T}\ddot{q}_{b}=Q_{X}_{_{Rb}}

MŸ_{Rb}−\dot{θ}² cos(θ)ψ₀^{T}q_{b}−2\dot{θ} sin(θ)ψ₀^{T}\dot{q}_{b}−\ddot{θ} sin(θ)ψ₀^{T}q_{b}+cos(θ)ψ₀^{T}\ddot{q}_{b}+Mg=Q_{Y}_{_{Rb}}

−(\ddot{X}_{Rb} cos(θ)+Ÿ_{Rb} sin(θ))ψ₀^{T}q_{b}+I_{b}\ddot{θ}+\ddot{θ}q_{b}^{T}q_{b}+2\dot{θ}\dot{q}_{b}^{T}q_{b}+ψ₁^{T}\ddot{q}_{b}=Q_{θ}

(−\ddot{X}_{Rb} sin(θ)+Ÿ_{Rb} cos(θ))ψ₀+\ddot{θ}ψ₁+\ddot{q}_{b}+Λq_{b}−\dot{θ}²q_{b}=Q_{q}_{_{b}} (6.2.7)

Equations (6.2.8)-(6.2.11) provide the non-conservative forces corresponding to the general coordinates of the rigid body and the elastic modal:

Q_{X}_{_{Rb}}= [symbol] pnₛdl (6.2.8)

Q_{Y}_{_{Rb}}= [symbol] pn_{η}dl (6.2.9)

Q_{θ}= [symbol] p(Xₚnₚ−Yₚnₛ)dl (6.2.10)

Q_{q}_{_{b}}= [symbol] p(n·e_{η})φdl (6.2.11)

wherein, nₛ and n_{η} are local normal components of s and η respectively, expressed by a fixed global coordinate system, Xₚ and Yₚ are overall X and Y coordinates of a point of action of an intensity of pressure p, e_{η} is an unit vector of o-η axis, and the integration is carried out around a perimeter of the beam of the structural motion description mode;

S6.3. Solving the Governing Equation of Solid Response which Couples the Rigid Body and the Elastic Mode.

Specific steps of the step S8 are as follows:

Assuming that all fluid and structural variables are known in time step t=tₖ₋₁, and then the detailed interaction process at the next time t=tₖ is as follows:

S8.1. assuming that an acceleration of a structure at the time step t=tₖ is the same as the acceleration at the previous time step t=tₖ₋₁, that is, \ddot{D}^{k}=\ddot{D}^{k-1}, a position D^{k} and a speed \dot{D}^{k} of a position at the time step t=tₖ can also be calculated by a finite difference method.

Calculating the corresponding position, velocity and acceleration of each point on the interface between fluid and structure through equations (8.1.1) (8.1.2) and (8.1.3)˜(8.1.6), that is, Γ_{fsi,0}^{(k)}, \dot{Γ}_{fsi,0}^{(k)} and \ddot{Γ}_{fsi,0}^{(k)} can be calculated from the newly calculated structural motion and deformation parameters D, that is equation (2.1.1),

$$\begin{matrix} {X}_{R} = {X}_{CR} + {R}_{{RX}_{R}} & ( 8.1 .1 ) \\ {X}_{fi} = {X}_{cfi} + {R}_{fi} {ξ}_{i}^{T} & ( 8.1 .2 ) \\ {\dot{X}}_{R} = {\dot{X}}_{CR} + {\dot{R}}_{{RX}_{R}} = {\dot{X}}_{C} R + {\dot{R}}_{R} U {\dot{θ}}_{R} {χ}_{R} & ( 8.1 .3 ) \\ {\dot{X}}_{fi} = {\dot{X}}_{cR} + {\dot{R}}_{R} {χ}_{ofi} + {\dot{R}}_{fi} {ξ}_{i}^{T} + {\dot{R}}_{fi} {\dot{ξ}}_{i}^{T} = {\dot{X}}_{CR} + {R}_{R} U {\dot{θ}}_{R} {χ}_{ofi} + {R}_{fi} U {\dot{θ}}_{fi} {χ}_{ofi} {ξ}_{i} + {R}_{fi} {\dot{ξ}}_{i} & ( 8.1 .4 ) \\ {\ddot{X}}_{R} = {\ddot{X}}_{CR} + {\ddot{R}}_{R} {χ}_{R} = {\ddot{X}}_{R} + ( {R}_{R} U {\ddot{θ}}_{R} - {R}_{R} {\ddot{θ}}_{R}^{2} ) {χ}_{R} & ( 8.1 .5 ) \\ \begin{matrix}{\ddot{X}}_{fi} = & {\ddot{X}}_{CR} + {\ddot{R}}_{R} {χ}_{ofi} + {\ddot{R}}_{fi} {ξ}_{i} + 2 {\dot{R}}_{fi} {\dot{ξ}}_{i} + {R}_{fi} {\ddot{ξ}}_{i} \\ = & {\ddot{X}}_{CR} + ( {R}_{R} U {\ddot{θ}}_{R} - {R}_{R} {\ddot{θ}}_{R}^{2} ) {χ}_{ofi} + ( {R}_{fi} U {\ddot{θ}}_{fi} - {R}_{fi} {\ddot{θ}}_{fi}^{2} ) {ξ}_{i} + \\ & 2 {R}_{fi} U {\ddot{θ}}_{fi} {\dot{ξ}}_{i} + {R}_{fi} {\ddot{ξ}}_{i}\end{matrix} & ( 8.1 .6 )\end{matrix}$$

wherein, X_{R} is a global coordinates of rigid body, X_{CR} is a center-of-mass coordinates, R_{R} is a rotation matrix that associates the local coordinate system soη with the fixed global coordinate system XOY; X_{fi} represents the coordinates on a center line; and represents the coordinates of the beam center line in the local coordinate system soη, as represented in equation (8.1.7), wherein 77; is deflection function of the beam of the structural motion description model;

ξᵢ=[sᵢ,ηᵢ] (8.1.7)

S8.2. calculating the fluid motion at time t=tₖ according to the modified MPS method by using the updated information of the interface as a new boundary condition, by using a newly updated pressure p_{fsi,i+1}^{k}; the i^{th} iteration of the interface at time t=tₖ can be conducted;

S8.3. comparing structural position differences Γ_{fsi,i}^{k} and \tilde{Γ}_{fsi,i+1}^{k} in step S2 and step S7, if a convergence condition is satisfied, as shown in equation (8.3.1), performing step S8.1 for the next time step t=tₖ₊₁ operation,

|\tilde{Γ}_{fsi,i+1}^{k}−Γ_{fsi,i}^{k}|≤ϵ (8.3.1)

otherwise, using equation (8.3.2) to correct the structural position Dᵢ₊₁^{k} of the (i+1)^{th} iteration, and using Newmark method to update velocity \dot{D}ᵢ₊₁^{k} and acceleration \ddot{D}ᵢ₊₁^{k}, calculating interface variables Γ_{fsi,i+1}^{k}, \dot{Γ}_{fsi,i+1}^{k} and \ddot{Γ}_{fsi,i+1}^{k} based on Dᵢ₊₁^{k}, \dot{D}ᵢ₊₁^{k}, and \ddot{D}ᵢ₊₁^{k}; using these modified interface variables, to perform the (i+1)^{th} iteration by returning to step S2,

Dᵢ₊₁^{k}=χᵢ\tilde{D}ᵢ₊₁^{k}+(1−χᵢ)Dᵢ^{k} (8.3.2)

wherein, χᵢ is Aitken relaxation factor, a core idea of which is to improve the accuracy of prediction by using the first two iterations. χᵢ is calculated by equation (8.3.3):

$${χ}_{i} = {χ}_{i - 1} \frac{{( {ΔΓ}_{fsi , i}^{k} )}^{T} ( {ΔΓ}_{fsi , i + 1}^{k} - {ΔΓ}_{fsi , i}^{k} )}{{( {ΔΓ}_{fsi , i + 1}^{k} - {ΔΓ}_{fsi , i}^{k} )}^{T} ( {ΔΓ}_{fsi , i + 1}^{k} - {ΔΓ}_{fsi , i}^{k} )} \qquad ( 8.3 .3 )$$

wherein, Γ_{fsi,i}^{k}=\tilde{Γ}_{fsi,i}^{k}−Γ_{fsi,i-1}^{k}. The initial value of each first iteration is 0.2.

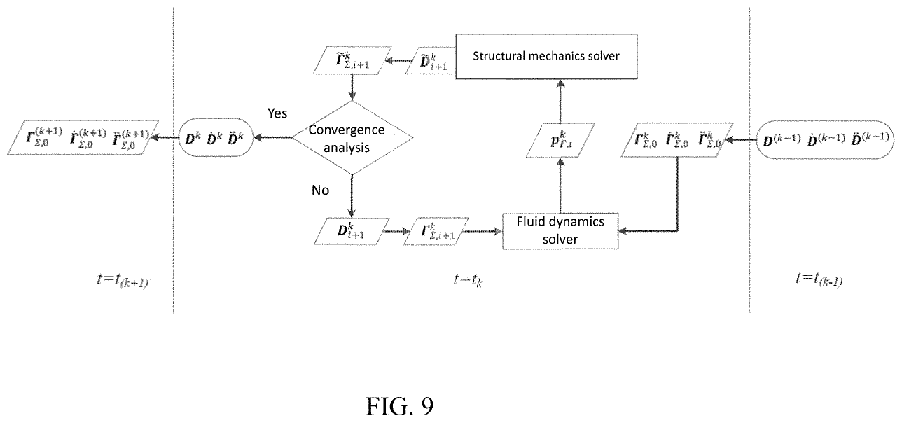

The entire process is shown in FIG. 9.

Hereafter, the method based on the moving particle semi-implicit method and modal superposition method to solve the strong nonlinear time-domain hydroelastic problem is used to calculate the three-dimensional hull slamming problem, and the applicability of the method is explained.

Specific Calculation Process:

### 1. Model Selection

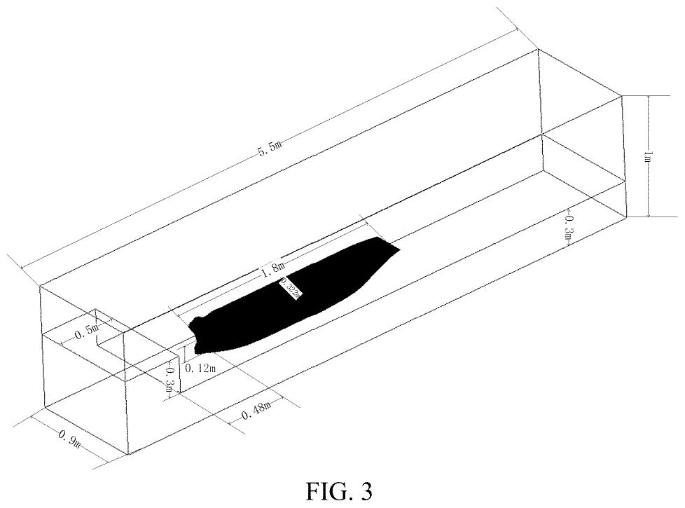

A 1:100 model of a 4,600-ton tanker was used to simulate an interaction between a dam-break wave and a ship. Assuming that the ship's dynamic response is two-dimensional (that is, only considering pitch, heave and vertical bending), this makes the elastic non-uniform beam suitable for this situation. The main parameters of the ship model are shown in Table 1. The ship model is placed in the pool facing the impact of the dam failure. The initial configuration is shown in FIG. 3. The width and length of the water tank are about three times the width and length of the ship.

TABLE 1
Main parameters of ship model

| | |
|---|---|
| Length of ship | 1.8 m |
| Width of ship | 0.322 m |
| Ship body's draught | 0.12 m |
| Mass of ship body | 54.99 kg |

### 2. Particle Discretization

The surface of the ship model is discretized using particles and the detailed procedure is as follows:

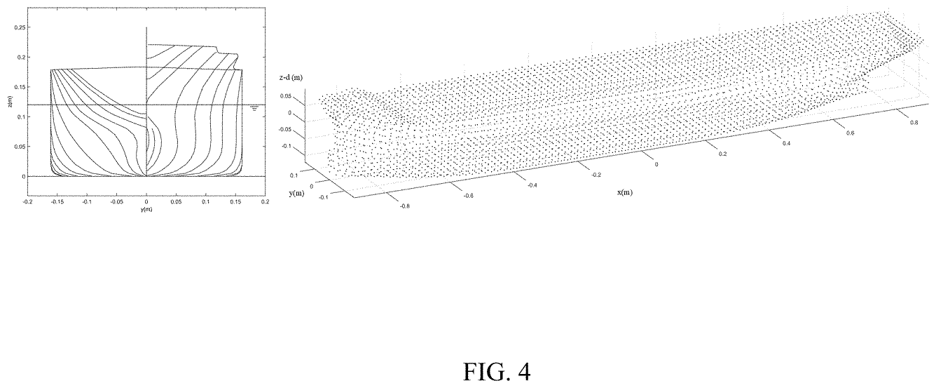

(1) the ship model is first discretized along the longitude direction with several cross-sections, i.e. stations (the norms of these cross-sections are parallel to the longitude direction) as shown in FIG. 4(a), the distance between each section is set as the value for initial fluid particles.

(2) for each section, the outline of the cross section is then discretized by evenly distributed particles.

The cross section and surface discretization of the ship model is shown in FIG. 4. The particle spacing on the surface of the ship model is approximately the same as the resolution of the flow field, which is 0.02 m (about 1/90 of the length of the ship model). The total number of particles is 289417, including 193284 fluid particles.

### 3. Parameter Selection

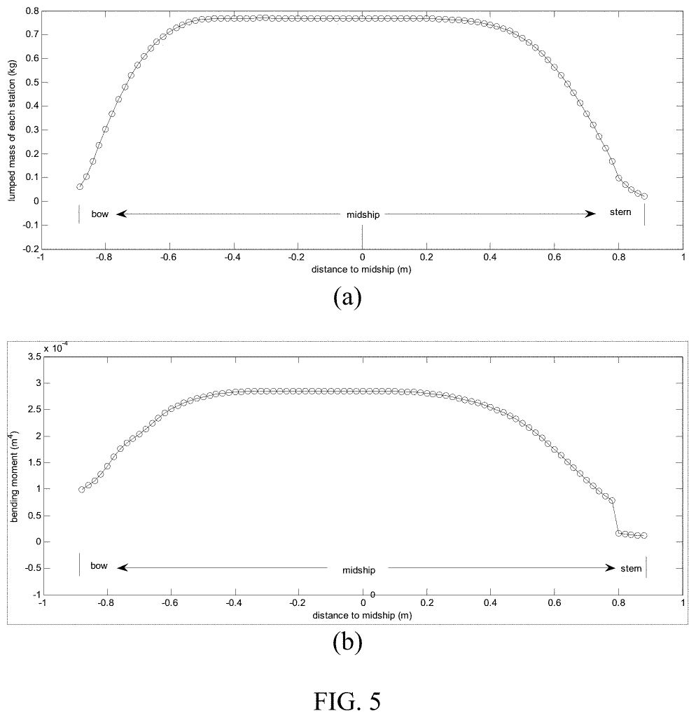

Assuming that the mass distribution of the ship model is the same as its water consumption, the thickness of the ship model is 0.05 m for the calculation of the second moment of section. FIG. 5 shows the distribution of the mass and second moment of the ship model.

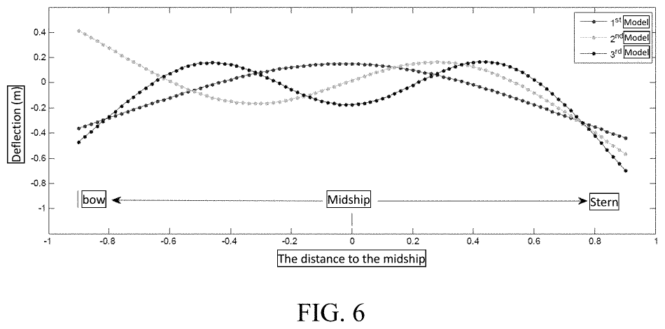

Myklestad's method is used to calculate the mode function of the elastic non-uniform beam. The results of the first three order mode functions are shown in FIG. 6. Young's modulus E=2×10⁴ N/m², and the first three circular natural frequency modes are: ω₁=3.7857, ω₂=9.7777, ω₃=18.2063

### 4. Calculation Result

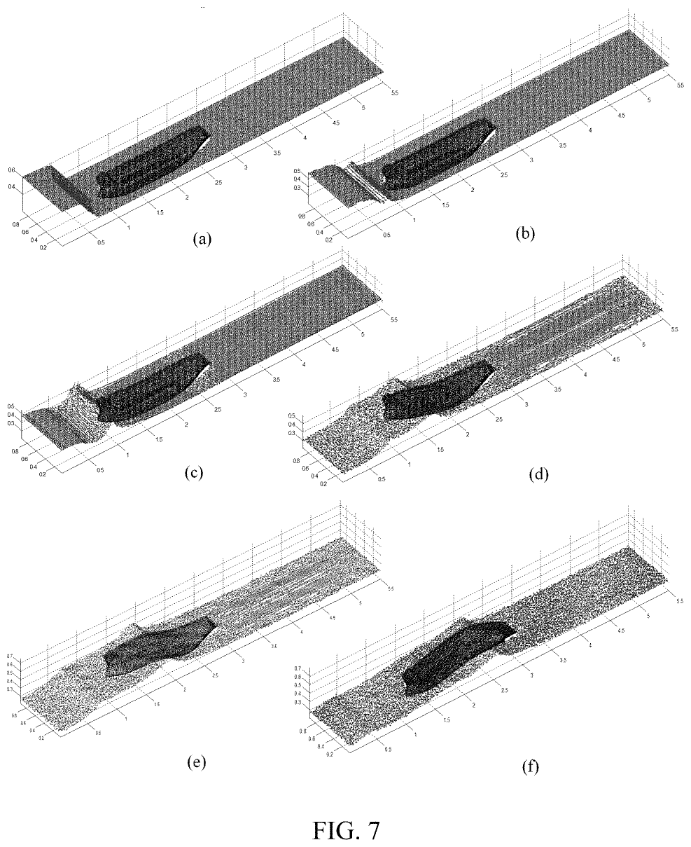

Some typical time-step free surface shapes and ship deformation diagrams are shown in FIG. 7. The free surface particles, the particles of the ship model part above the free surface and the particles of the ship model part below the free surface are marked as red, blue and black, respectively. It can be seen from FIG. 7 that no free surface particles are erroneously identified below the free surface. In this simulation, the deformation amplitude is significantly larger than the normal ship model structure. The lower stiffness is deliberately selected to test the coupling ability between the modified modal superposition and the MPS model. FIGS. 7 (a), (b), (c) show the shock wave motion processes at different times of dam failure. The fact that the draft of the ship model remains unchanged proves that the buoyancy calculated by MPS is accurate and stable for the support of the weight of the ship model. The impact of the waves on the ship's bow occurs at t=0.418 s in FIG. 7(c). When the wave propagates along the ship model, the maximum bending moment is generated at the peak of the wave (FIGS. 7 (d)-(f)), and the ship model accordingly generates the largest deformation. Qualitative analysis shows that the coupling between the modified MPS and the mentioned structural model can provide reasonable results for the simulation of wave-structure interaction.

At last, it should be stated that the above various embodiments are only used to illustrate the technical solutions of the present invention without limitation; and despite reference to the aforementioned embodiments to make a detailed description of the present invention, those of ordinary skilled in the art should understand: the described technical solutions in above various embodiments may be modified or the part of or all technical features may be equivalently substituted; while these modifications or substitutions do not make the essence of their corresponding technical solutions deviate from the scope of the technical solutions of the embodiments of the present invention.

1. A method for analyzing hydroelastic effect of a marine structure based on moving particle semi-implicit method and modal superposition method, comprising the following steps:
S1. spatially discretizing a boundary of a flow field with mesh-less discrete points, wherein the boundary of the flow field is a surface of the marine structure in contact with a fluid, wherein if a previous time step is initial time, velocity and intensity of pressure of fluid particles need to be initialized;
S2. determining an estimated value of a structural boundary position of a current time step according to motion information of a solid boundary of the previous time step, wherein if the previous time step is the initial time, an initial value of a structural motion is adopted;
S3. updating a position and a velocity of fluid particles by Navier-Stokes equation according to flow field information of the previous time step, excluding fluid pressure;
S4. deriving a pressure Poisson equation and solving the pressure Poisson equation;
S5. updating the position and the velocity of the fluid particles using a pressure value in S4;
S6. solving the governing equation of solid response, which couples the rigid body and elastic mode, by using the pressure value obtained in S4;
S7. updating the structure motion and deformation by using dynamic information obtained in step S6, which in turn provides a new fluid boundary position;
S8. comparing structural position differences in step S2 and step S7, wherein if a convergence condition is satisfied, a next time step calculation is performed, otherwise, repeating steps S2 to S8 at a current time step until the next time step calculation is performed after the convergence condition is satisfied.

2. The method according to claim 1, wherein, specific steps of the step S1 are as follows: discretizing based on uniformly distributed particles, as shown in equation (1.1.1)
$$\begin{matrix}∇ φ ( {r}_{i} ) = \frac{{d}_{m}}{{n}_{0}} {\sum }_{j \neq i}^{N} \frac{φ ( {r}_{j} ) - φ ( {r}_{i} )}{{r}_{ij}^{2}} ( {r}_{j} - {r}_{i} ) W ( {r}_{ij} ) & ( 1 ) \\ {∇}^{2} φ ( {r}_{i} ) = \frac{2 {d}_{m}}{{n}_{0} λ} {\sum }_{j \neq i}^{N} [ φ ( {r}_{j} ) - φ ( {r}_{i} ) ] W ( {r}_{ij} ) & ( 2 ) ( 1.1 .1 ) \\ ∇ \cdot Φ ( {r}_{i} ) = \frac{{d}_{m}}{{n}_{0}} {\sum }_{j \neq i}^{N} \frac{( Φ ( {r}_{j} ) - Φ ( {r}_{i} ) ) \cdot ( {r}_{j} - {r}_{i} )}{{r}_{ij}^{2}} W ( {r}_{ij} ) & ( 3 )\end{matrix}$$
wherein, ϕ and Φ represent arbitrary scalars and vectors respectively, dₘ represents a number of dimensions of the problem under study: two dimensions or three dimensions, N is a number of particles in an affected area of the relevant particles; no is a particle density at initial time, r represents a particle spacing, and rᵢ and rⱼ represent the coordinates of particle i and particle j respectively, rᵢⱼ=|rᵢ−rⱼ|;
a kernel function W (rᵢⱼ) and a parameter λ are defined as equation (1.1.2) and equation (1.1.3):
$$\begin{matrix}W ( {r}_{ij} ) = \{ \begin{matrix}\frac{{r}_{e}}{{r}_{ij}} - 1 & 0 \leq {r}_{ij} \leq {r}_{e} \\ 0 & {r}_{ij} \geq {r}_{e}\end{matrix} & ( 1.1 .2 ) \\ λ = \frac{{\sum }_{j \neq i}^{N} W ( {r}_{ij} ) {r}_{ij}^{2}}{{\sum }_{j \neq i}^{N} W ( {r}_{ij} )} & ( 1.1 .3 )\end{matrix}$$
wherein, rₑ represents an effective range of particles interaction, and the particle density n is defined in equation (1.1.4):
$$n = {\sum }_{j \neq i}^{N} W ( {r}_{ij} ) \qquad ( 1.1 .4 )$$
an adjustment amount of the particle spacing r as shown in equation (1.1.5):
$$δ {r}_{i} = {\sum }_{j \neq i} \frac{{r}_{0 -} \vert {r}_{ij} \vert}{2} \cdot \frac{{r}_{i -} {r}_{j}}{\vert {r}_{ij} \vert} , when \vert {r}_{ij} \vert \leq {r}_{0} \qquad ( 1.1 .5 )$$
wherein, r₀ is an initial particle spacing;
for free surface particles distal from a main fluid domain, when a relative velocity between the particles is closer than a threshold before a prediction step S3, performing an operation as shown in equation (1.1.6) to set the relative velocity of the particle pair δuᵢ to be zero;
$$δ {u}_{i} = {\sum }_{j \neq i} - □ ( {r}_{ij} ) {u}_{{τ}_{ij}} , when \vert {r}_{ij} - {u}_{{τ}_{ij}} Δ t \vert \leq {r}_{min} \vert , {r}_{min} = 0.3 {r}_{0} \qquad ( 1.1 .6 )$$
wherein, uᵣ_{ᵢⱼ} is a relative tangential velocity of particle i and particle j, and the adjacent particles of solid and fluid are taken as 0.5 and 1.0 respectively; Δt is a size of the time step.

3. The method according to claim 2, wherein, specific steps of the step S2 are as follows:
introducing a variable A describing the motion and deformation of an object, which is defined as follows:
A=[X_{Rb},θ,q_{b}] (2.1.1)
wherein, X_{Rb} represents a position of a center of mass of a rigid body motion, B represents a deadrise angle of the structure, and q_{b} represents general coordinates corresponding to a modal function;
the corresponding position, velocity and acceleration of the particles at an interface of the structure and the fluid are Γ_{fsi,0}^{k}, \dot{Γ}_{fsi,0}^{k}, and \ddot{Γ}_{fsi,0}^{k}, wherein k represents a time step, a position where a subscript ‘0’ locates represents a number of iterations;
estimating a position, velocity and acceleration of the current time step from the position Γ_{fsi,0}^{k-1}, velocity \dot{Γ}_{fsi,i}^{k-1} and acceleration \ddot{Γ}_{fsi,0}^{k-1} of the structure boundary particles of the previous time step according to an assumption of uniform acceleration motion, and calculating an estimated value of the structural boundary position of the current time step based on the calculated position, velocity and acceleration of the current time step.

4. The method according to claim 3, wherein, in the step S3, the Lagrangian form non-viscous Navier-Stokes equation is shown in equation (3.1.1):
$$\frac{Du}{Dt} = g - \frac{∇ p}{ρ} \qquad ( 3.1 .1 )$$
wherein, u, p and ρ respectively represent a velocity, pressure and density of the fluid, which are all vectors pointing in a direction of gravity, and g is the acceleration of gravity;
specific steps of the step S3 are as follows:
using a classic projection method to decouple the speed and pressure as follows:
without considering the pressure, updating the liquid to an intermediate state only by inertia, as shown in equation (3.1.2):
u_{*}=uₖ+Δtg (1)
l_{*}=lₖ+Δtu_{*} (2)(3.1.2)
wherein, l is a position vector, variables with subscripts * and k respectively represent variables at an intermediate time step and a k^{th} time step, and u represents the velocity of the fluid.

5. The method according to claim 4, wherein, specific steps of the step S4 are as follows:
deriving the pressure Poisson equation by taking a divergence of the Navier-Stokes equation on both sides according to a continuity equation, as shown in equation (4.1.2), wherein, the continuity equation is shown in equation (4.1.1),
$$\begin{matrix}∇ \cdot u = 0 & ( 4.1 .1 ) \\ {∇}^{2} {p}_{k + 1} = \frac{ρ ∇ \cdot {u}_{*}}{Δ t} + αρ \frac{{n}_{0} - {n}_{k}}{{n}_{0} Δ {t}^{2}} & ( 4.1 .2 )\end{matrix}$$
wherein, n₀ and nₖ are the particle densities at the initial time and the k^{th} time step respectively, and the particle density is defined as shown in equation (1.1.4);
the coefficient α is defined as shown in (4.1.3):
$$α = \{ \begin{matrix}\vert \frac{{n}_{0} - {n}_{k}}{{n}_{0}} \vert + Δ t \vert ∇ \cdot {u}_{k} \vert & ( {n}_{0} - {n}_{k} ) ∇ \cdot {u}_{k} \geq 0 \\ \vert \frac{{n}_{0} - {n}_{k}}{{n}_{0}} \vert & ( {n}_{0} - {n}_{k} ) ∇ \cdot {u}_{k} \leq 0\end{matrix} \qquad ( 4.1 .3 )$$
boundary conditions for solving the pressure Poisson equation are as follows:
(1) solid boundary conditions
applying Neumann boundary conditions to solid particles, as shown in equation (4.1.4),
n·∇pₖ₊₁=ρ(n·g−n·\dot{u}_{b}_{ₖ₊₁})≈ρ(n·g−n·\dot{u}_{b}_{ₖ}) (4.1.4)
wherein, \dot{u}_{b}_{ₖ} and \dot{u}_{b}_{ₖ₊₁} are the accelerations of the solid boundary particles at the k^{th} and (k+1)^{th} time steps; since \dot{u}_{b}_{ₖ₊₁} is unknown when solving the fluid motion at the (k+1)^{th} time step, the value \dot{u}_{b}_{ₖ} of the previous time step is used as an approximation;
fluid particles proximal to the solid boundary need to be corrected for the Laplace operator, wherein a pressure value is shown in equation (4.1.5), and a discrete term in equation (1.1.1) is corrected to make it consistent with equation (4.1.2); an intermediate velocity of the affected solid boundary particles is corrected as equation (4.1.6)-(1), which then are projected to tangential r and normal n directions respectively to obtain equations (4.1.6)-(2) and (4.1.6)-(3),
$$\begin{matrix}{p}_{v} = {p}_{s} + {ρ}_{0} ( n \cdot g - n \cdot {u}_{b} ) {r}_{0} & ( 4.1 .5 ) \\ {u}_{{b}^{*}} = {u}_{bk + 1} + Δ t \frac{∇ {p}_{k}}{{ρ}_{0}} & ( 1 ) \\ n \cdot {u}_{{b}^{*}} = n \cdot {u}_{bk + 1} + Δ t ( n \cdot g - n \cdot {\dot{u}}_{{b}_{k}} ) & ( 2 ) ( 4.1 .6 ) \\ τ \cdot {u}_{{b}^{*}} = τ \cdot {u}_{bk + 1} + \frac{Δ t}{{ρ}_{0}} \frac{\partial {p}_{k}}{\partial τ} & ( 3 )\end{matrix}$$
wherein, pᵥ represents an intensity of pressure of virtual particles, pₛ represents an intensity of pressure of responsive solid particles, u_{b*} and u_{b}_{ₖ₊₁} are the velocity of the solid boundary particles at the intermediate time and the (k+1)^{th} time step, and n in equations (4.1.5) and (4.1.6) represents a normal direction;
(2) free surface boundary condition
since solving the pressure Poisson equation requires applying a boundary condition with zero pressure on the free surface boundary, it is necessary to identify a position of the free surface particles:
for the case of two dimensions, each particle is assigned a circle centered on itself with a radius of 1.05r₀, and the circle is discretized with 360 points evenly distributed on it; if all these points are covered by the circles of its neighboring particles, then the particle is an internal fluid particle, otherwise the particle is to be identified as a free surface particle;
for the case of three dimensions, a two-step method is used:
firstly, checking a number of adjacent particles using equation (4.1.7) to detect potential free surface particles,
Nₚ<β_{3d}Nₚ₀ (4.1.7)
β_{3d} is a parameter less than 1, taking values according to situations, and Nₚ₀ represents a initial particle density within a delimited range;
secondly, refining a search by establishing a spherical surface with a radius of 1.05r₀ centered on the particle, in detail: determining a vector pointing to the most sparse direction of a particle distribution around the particle by weighted average method, and discretizing a circular area on the spherical surface by uniformly distributed points, if all these points are covered by the spherical surface of its neighboring particles, the particle is an internal fluid particle, otherwise the particle will be identified as a free surface particle.

6. The method according to claim 5, wherein, calculation equation of step S5 is as shown in equation (5.1.1),
$${u}_{k + 1} = {u}_{*} - Δ t \cdot \frac{∇ {p}_{k + 1}}{{ρ}_{0}} \\ {r}_{k + 1} = {r}_{k} + Δ t \cdot {u}_{k + 1} \qquad ( 5.1 .1 )$$

7. The method according to claim 6, wherein, specific steps of the step S6 are as follows:
S6.1. establishment of structural motion description model
the structural motion description model uses a fixed global coordinate system XOY and an attachment local coordinate system soη, wherein an origin of the attachment local coordinate system is selected at a center of gravity of a beam of the structural motion description model, a position X of any point on the beam of the structural motion description model can be described by equation (6.1.1),
X=X_{Rb}+Rξ^{T} (6.1.1)
wherein, X_{Rb} is a position of a center of mass of the beam of the structural motion description model, and equations (6.1.2) and (6.1.3) define local coordinates ξ of the beam of the structural motion description model and rotation matrix R of the beam of the structural motion description model,
$$\begin{matrix}ξ = [ s , {η}_{l} + {η}_{0} ] & ( 6.1 .2 ) \\ R = [ \begin{matrix}cos ( θ ) & - sin ( θ ) \\ sin ( θ ) & cos ( θ )\end{matrix} ] & ( 6.1 .3 )\end{matrix}$$
wherein, θ is an angle between O-X axis and o-s axis counterclockwise, η₁ is a coordinate of an undeformed structure, which is a constant for a specific point on the beam of the structural motion description model, and η₀ is a deflection of a mid-plane, the deflection of any plane parallel to the mid-plane taking the same value of the mid-plane; according to a modal superposition theory, the deflection η₀ of the mid-plane is expanded into equation (6.1.4),
η₀=φ^{T}q_{b} (6.1.4)
equations (6.1.5) and (6.1.6) define a column vector φ of a modal function and corresponding general coordinates q_{b},
φ=[φ₁,φ₂,φ₃, . . . ]^{T} (6.1.5)
q_{b}=[q_{b1},q_{b2},q_{b3}, . . . ]^{T} (6.1.6)
the modal function satisfies the following orthogonal relationship:
$$\begin{matrix}{\int }_{{s}_{1}}^{{s}_{2}} {ϕρ}_{l} {ϕ}^{T} ds = {I}_{u} , {I}_{u} is an identity matrix & ( 6.1 .7 ) \\ {\int }_{{s}_{1}}^{{s}_{2}} \frac{{d}^{2} ϕ}{{ds}^{2}} {EI}_{I} \frac{{d}^{2} {ϕ}^{T}}{{ds}^{2}} ds = Λ , Λ = diag ( {ω}_{i}^{2} ) i = 1 , 2 , 3 , … & ( 6.1 .8 )\end{matrix}$$
wherein s₁ and s₂ are upper and lower limits integrated along o-s axis, ρₗ is an line density of the beam of the structural motion description model, E represents an elastic modulus of a structure, and I_{I} is an inertia matrix of the structure;
S6.2. establishment of the governing equation of solid response based on Lagrange equation establishing a model based on Lagrange equation
$$\frac{d}{dt} ( \frac{\partial T}{\partial {\dot{q}}_{j}} ) + \frac{\partial U}{\partial {q}_{j}} - \frac{\partial T}{\partial {q}_{j}} = {Q}_{j} j = 1 , 2 , 3 , … \qquad ( 6.2 .1 )$$
wherein T and U respectively represent kinetic energy and potential energy of the structural motion description model, qⱼ is a general coordinate corresponding to any rigid-flexible mode, and Qⱼ is a non-conservative force corresponding to the j^{th} coordinate;
the beam of the structural motion description model is an elastic non-uniform beam, and specific forms of T, U, qⱼ, Qⱼ of the elastic non-uniform beam are as follows:
$$\begin{matrix}\begin{matrix}T = & \frac{1}{2} {\int }_{{s}_{1}}^{{s}_{2}} {\int }_{{η}_{1}}^{{η}_{2}} {\dot{X}}^{T} {ρ}_{s} \dot{X} d η ds = \\ & \frac{1}{2} {\int }_{{s}_{1}}^{{s}_{2}} {\int }_{{η}_{1}}^{{η}_{2}} {( {\dot{X}}_{R} + RU \dot{θ} ξ + R \dot{ξ} )}^{T} {ρ}_{s} ( {\dot{X}}_{R} + RU \dot{θ} ξ + R \dot{ξ} ) d η ds \\ = & \frac{1}{2} [ M ( {\dot{X}}_{R}^{2} + {\dot{Y}}_{R}^{2} ) + {\dot{θ}}^{2} {I}_{b} + {\dot{θ}}^{2} {q}_{b}^{T} {q}_{b} + {\dot{q}}_{b}^{T} {\dot{q}}_{b} - \\ & 2 \dot{θ} ( {\dot{X}}_{R} cos ( θ ) + {\dot{Y}}_{R} sin ( θ ) ) {q}_{b}^{T} {ψ}_{0} + \\ & 2 ( - {\dot{X}}_{R} sin ( θ ) + {\dot{Y}}_{R} cos ( θ ) ) {\dot{q}}_{b}^{T} {ψ}_{0} + 2 \dot{θ} {\dot{q}}_{b}^{T} {ψ}_{1} ]\end{matrix} & ( 6.2 .2 ) \\ \begin{matrix}U = & \frac{1}{2} {\int }_{{s}_{1}}^{{s}_{2}} \frac{{d}^{2} {η}_{0}}{{ds}^{2}} EI \frac{{d}^{2} {η}_{0}}{{ds}^{2}} ds + {MgY}_{R} \\ = & \frac{1}{2} {q}_{b}^{T} ( {\int }_{{s}_{1}}^{{s}_{2}} \frac{{d}^{2} ϕ}{{ds}^{2}} EI \frac{{d}^{2} {ϕ}^{T}}{{ds}^{2}} ds ) {q}_{b} + \\ & {MgY}_{R} = \frac{1}{2} {q}_{b}^{T} Λ {q}_{b} + {MgY}_{R}\end{matrix} & ( 6.2 .3 )\end{matrix}$$
wherein ρₛ represents a linear density, M represents mass of a structure, X_{R} and Y_{R} correspond to X and Y coordinates of a center of mass of the structure respectively, g represents the acceleration of gravity, η₁ and η₂ are the upper and lower limits of integral along axis η, matrix integral U and column vector integrals Ψ₀ and Ψ₁, the matrix integral U and column vector integrals Ψ₀, Ψ₁ defined in equations (6.2.4) and (6.2.6):
$$\begin{matrix}U = [ \begin{matrix}0 & - 1 \\ 1 & 0\end{matrix} ] & ( 6.2 .4 ) \\ {ψ}_{0} = {[ {ψ}_{01} , {ψ}_{02} , {ψ}_{03} , … ]}^{T} = {\int }_{{s}_{1}}^{{s}_{2}} {ϕρ}_{l} ds & ( 6.2 .5 ) \\ {ψ}_{1} = {[ {ψ}_{11} , {ψ}_{12} , {ψ}_{13} , … ]}^{T} = {\int }_{{s}_{1}}^{{s}_{2}} s {ϕρ}_{l} ds & ( 6.2 .6 )\end{matrix}$$
obtaining the governing equations of the dynamic response for elastic non-uniform beam under a wave impact by substituting equations (6.2.2) and (6.2.3) into equation (6.2.1), which is shown in equation (6.2.7):
M\ddot{X}_{Rb}+\dot{θ}² sin(θ)ψ₀^{T}q_{b}−2\dot{θ} cos(θ)Ψ₀^{T}\dot{q}_{b}−\ddot{θ} cos(θ)Ψ₀^{T}q_{b}−sin(θ)Ψ₀^{T}\ddot{q}_{b}=Q_{X}_{_{Rb}}
MŸ_{Rb}−\dot{θ}² cos(θ)ψ₀^{T}q_{b}−2\dot{θ} sin(θ)ψ₀^{T}\dot{q}_{b}−\ddot{θ} sin(θ)ψ₀^{T}q_{b}+cos(θ)ψ₀^{T}\ddot{q}_{b}+Mg=Q_{Y}_{_{Rb}}
−(\ddot{X}_{Rb} cos(θ)+Ÿ_{Rb} sin(θ))ψ₀^{T}q_{b}+I_{b}\ddot{θ}+\ddot{θ}q_{b}^{T}q_{b}+2\dot{θ}\dot{q}_{b}^{T}q_{b}+ψ₁^{T}\ddot{q}_{b}=Q_{θ}
(−\ddot{X}_{Rb} sin(θ)+Ÿ_{Rb} cos(θ))ψ₀+\ddot{θ}ψ₁+\ddot{q}_{b}+Λq_{b}−\dot{θ}²q_{b}=Q_{q}_{_{b}} (6.2.7)
equations (6.2.8)-(6.2.11) provide the non-conservative forces corresponding to the general coordinates of the rigid body and the elastic modal:
Q_{X}_{_{Rb}}= [symbol] pnₛdl (6.2.8)
Q_{Y}_{_{Rb}}= [symbol] pn_{η}dl (6.2.9)
Q_{θ}= [symbol] p(Xₚnₚ−Yₚnₛ)dl (6.2.10)
Q_{q}_{_{b}}= [symbol] p(n·e_{η})φdl (6.2.11)
wherein, nₛ and n_{η} are local normal components of s and η respectively, expressed by a fixed global coordinate system, Xₚ and Yₚ are overall X and Y coordinates of a point of action of an intensity of pressure p, e_{η} is an unit vector of o-η axis, and the integration is carried out around a perimeter of the beam of the structural motion description mode;
S6.3. solving the governing equation of solid response which couples the rigid body and the elastic mode.

8. The method according to claim 6, wherein, specific steps of the step S8 are as follows:
assuming that all fluid and structural variables are known in a time step t=tₖ₋₁, and then the detailed interaction process at the next time step t=tₖ is as follows:
S8.1. assuming that an acceleration of a structure at the time step t=tₖ is the same as the acceleration at the previous time step t=t_{k-1,} that is, \ddot{D}^{k}=\ddot{D}^{k-1}, a position D^{k} and a speed \dot{D}^{k} at the time step t=tₖ can also be calculated by a finite difference method;
calculating the corresponding position, velocity and acceleration of each point on the interface between fluid and structure through equations (8.1.1)˜(8.1.6), that is Γ_{fsi,0}^{(k)}, Γ_{fsi,0}^{(k)} and Γ_{fsi,0}^{(k)} can be calculated from the newly calculated structural motion and deformation parameters A, that is, equation (2.1.1),
$$\begin{matrix} {X}_{R} = {X}_{CR} + {R}_{{RX}_{R}} & ( 8.1 .1 ) \\ {X}_{fi} = {X}_{cfi} + {R}_{fi} {ξ}_{i}^{T} & ( 8.1 .2 ) \\ {\dot{X}}_{R} = {\dot{X}}_{CR} + {\dot{R}}_{{RX}_{R}} = {\dot{X}}_{C} R + {\dot{R}}_{R} U {\dot{θ}}_{R} {χ}_{R} & ( 8.1 .3 ) \\ {\dot{X}}_{fi} = {\dot{X}}_{cR} + {\dot{R}}_{R} {χ}_{ofi} + {\dot{R}}_{fi} {ξ}_{i}^{T} + {\dot{R}}_{fi} {ξ}_{i}^{T} = {\dot{X}}_{CR} + {R}_{R} U {\dot{θ}}_{R} {χ}_{ofi} + {R}_{fi} U {\dot{θ}}_{fi} {χ}_{ofi} {ξ}_{i} + {R}_{fi} {\dot{ξ}}_{i} & ( 8.1 .4 ) \\ {\ddot{X}}_{R} = {\ddot{X}}_{CR} + {\ddot{R}}_{R} {χ}_{R} = {\ddot{X}}_{R} + ( {R}_{R} U {\ddot{θ}}_{R} - {R}_{R} {\ddot{θ}}_{R}^{2} ) {χ}_{R} & ( 8.1 .5 ) \\ \begin{matrix}{\ddot{X}}_{fi} = & {\ddot{X}}_{CR} + {\ddot{R}}_{R} {χ}_{ofi} + {\ddot{R}}_{fi} {ξ}_{i} + 2 {\dot{R}}_{fi} {\dot{ξ}}_{i} + {R}_{fi} {\ddot{ξ}}_{i} \\ = & {\ddot{X}}_{CR} + ( {R}_{R} U {\ddot{θ}}_{R} - {R}_{R} {\ddot{θ}}_{R}^{2} ) {χ}_{ofi} + \\ & ( {R}_{fi} U {\ddot{θ}}_{fi} - {R}_{fi} {\ddot{θ}}_{fi}^{2} ) {ξ}_{i} + 2 {R}_{fi} U {\ddot{θ}}_{fi} {\dot{ξ}}_{i} + {R}_{fi} {\ddot{ξ}}_{i}\end{matrix} & ( 8.1 .6 )\end{matrix}$$
wherein, X_{R} is a global coordinates of rigid body, X_{CR} is a center-of-mass coordinates, R_{R} is a rotation matrix that associates the local coordinate system soη with the fixed global coordinate system XOY; X_{fi} represents the coordinates on a center line; and ξᵢ represents a coordinates of the beam center line in the local coordinate system soη, as represented in equation is (8.1.7), wherein ηᵢ is deflection function of the beam of the structural motion description model;
ξᵢ=[sᵢ,ηᵢ] (8.1.6)
S8.2. calculating the fluid motion at time t=tₖ according to the modified MPS method by using updated information of the interface as a new boundary condition, by using a newly updated pressure p_{fsi,i+1}^{k}, the i^{th} iteration of the interface at time t=tₖ being conducted;
S8.3. comparing structural position differences Γ_{fsi,i}^{k} and \tilde{Γ}_{fsi,i+1}^{k} in step S2 and step S7, if a convergence condition is satisfied, as shown in equation (8.3.1), performing step S8.1 for the next time step t=tₖ₊₁ operation,
Dᵢ₊₁^{k}=χᵢ\tilde{D}ᵢ₊₁^{k}+(1−χᵢ)Dᵢ^{k} (8.3.1)
otherwise, using equation (8.3.2) to correct the structural position Dᵢ₊₁^{k} of the (i+1)^{th} iteration, and using Newmark method to update velocity \dot{D}ᵢ₊₁^{k} and acceleration \ddot{D}ᵢ₊₁^{k}, calculating interface variables Γ_{fsi,i+1}^{k}, \dot{Γ}_{fsi,i+1}^{k} and \ddot{Γ}_{fsi,i+1}^{k} based on Dᵢ₊₁^{k}, \dot{D}ᵢ₊₁^{k} and \ddot{D}ᵢ₊₁^{k}; using these modified interface variable to perform the (i+1)^{th} iteration by returning to step S2,
Dᵢ₊₁^{k}=χᵢ\tilde{D}ᵢ₊₁^{k}(1−χᵢ)Dᵢ^{k} (8.3.2)
wherein, χᵢ is Aitken relaxation factor which is calculated by equation (8.3.3):
$${χ}_{i} = - {χ}_{i - 1} \frac{{( {ΔΓ}_{fsi , i}^{k} )}^{T} ( {ΔΓ}_{fsi , i + 1}^{k} - {ΔΓ}_{fsi , i}^{k} )}{{( {ΔΓ}_{fsi , i + 1}^{k} - {ΔΓ}_{fsi , i}^{k} )}^{T} ( {ΔΓ}_{fsi , i + 1}^{k} - {ΔΓ}_{fsi , i}^{k} )} \qquad ( 8.3 .3 )$$
wherein, ΔΓ_{fsi,i}^{k}=\tilde{Γ}_{fsi,i}^{k}−Γ_{fsi,i-1}^{k}.
